(19) United States
(12) Patent Application Publication
(10) Pub. No.: US 2013/0124311 A1
(43) Pub. Date: May 16, 2013

(54) System and Method for Dynamic Integration of Advertisements in a Virtual Environment

(71) Applicants: Sujai Sivanandan, Bangalore (IN); Vivek Kumar Pai, Bangalore (IN); Lavanya Gollahalli Sudhakar, Bangalore (IN); Hari Hara Subramani Krishnan, Bangalore (IN)

(72) Inventors: Sujai Sivanandan, Bangalore (IN); Vivek Kumar Pai, Bangalore (IN); Lavanya Gollahalli Sudhakar, Bangalore (IN); Hari Hara Subramani Krishnan, Bangalore (IN)

(21) Appl. No.: 12/409,299

(22) Filed: Mar. 23, 2009

(51) Int. Cl. G06Q 30/00; G06Q 30/02

(52) U.S. Cl. 705/14.51

(57) ABSTRACT

Systems and methods for dynamic integration of advertisements in 3D virtual environments may provide contextual placement of advertising assets into those environments. The advertising assets may include 3D models of products or advertisements. The selection of appropriate advertising assets during runtime may be dependent on context-sensitive metadata associated with placeholders tagged in the virtual environment by a virtual environment authoring application, and corresponding metadata associated with available advertising assets. The metadata may include classification attributes, visual attributes, physical attributes, behavioral attributes, or interactivity attributes. The selection of appropriate advertising assets may be further dependent on user information and/or game session information captured at runtime. Additional advertising assets may be dynamically selected in response to interactions with the advertising assets, or dependent on changes in status of a user or game session. The methods may be implemented as program instructions stored on computer-readable storage media, executable by a CPU and/or GPU.

### BACKGROUND

### Description of the Related Art

Advertisers are continually looking for new opportunities to present information to potential consumers. For example, advertisers provide advertising content to be presented to users of web browsers and search engines, and the advertising content presented to a given user may be context-specific, e.g., dependent on IP addresses accessed, search criteria entered, etc.

Recently, advertisers have been collaborating with the entertainment industry to place specific products and/or advertising content in movies, television shows, and electronic games. Product placements and advertising content for electronic games is typically hard-coded into the games themselves, or into upgrade packages that may be purchased and/or downloaded by consumers. Advertising content coded into electronic games is often represented as two-dimensional images (e.g., banners or logos). The advertising content and placed products found in current electronic games are static within the context of the game. In other words, once placed in the game, the placed products and advertising content are the same every time the game is played.

### SUMMARY

Placing advertising within virtual environments (such as those employed in an on-line game application) may be more effective if information relating to the product being advertised is available, as well as the context of the virtual world within which the advertisement is to “take place”. The systems and methods described herein may provide mechanisms to support dynamic placement of advertisements into a virtual world in the appropriate context, satisfying these business requirement. The systems and methods for dynamic integration of advertisements in virtual environments described herein may in some embodiments provide contextual placement of advertising assets into a three-dimensional (3D) virtual world.

Placeholders representing locations at which advertising may be presented may be inserted into data and/or instructions representing a given virtual environment using a virtual environment authoring application, in some embodiments. In such embodiments, the virtual environment authoring application may access data representing a virtual environment and may receive an indication of a placeholder in the virtual environment at which an advertising asset may be placed. For example, a graphical user interface may be provided to a graphic designer or game designer through which the user may “tag” a virtual environment with one or more placeholders for advertising assets. Tagging the virtual environment may include inserting instructions into the virtual environment representation configured to request an advertising asset in place of the placeholder at runtime, and storing the modified code for subsequent use in an application comprising one or more virtual environment representations (e.g., in an on-line game).

In various embodiments, the interface may allow the user to input data indicating values for various attributes of the placeholder, which may be stored as metadata associated with an identifier of the placeholder. Placeholder attributes may include classification attributes, visual attributes, physical attributes, behavioral attributes, and/or interactivity attributes, in various embodiments. In some embodiments, a placeholder may be associated with an image or frame of the virtual environment to be tagged with various attributes. In some embodiments, a placeholder may be associated only a portion of an image or frame of the virtual environment or may be associated with one or more objects in an image or frame of the virtual environment.

In some embodiments, the virtual environment authoring application may be configured to insert instructions into a game application or virtual environment representation, and these inserted instructions may be configured to capture user or session information at runtime.

The methods for selection of appropriate advertising assets to be integrated into a virtual environment during runtime may be dependent on the context-sensitive metadata associated with placeholders tagged in the virtual environment and corresponding metadata associated with various advertising assets. In some embodiments, the selection of appropriate advertising assets may be further dependent on user-specific information and/or game session information captured at runtime, as described above. At runtime, a game server or ad server may receive a request from an executing application (e.g., a game application) for an advertising asset to be integrated into a virtual environment displayed by the application. The request may include an indicator of a placeholder within the virtual environment at which an advertising asset is to be integrated.

The game or ad server may be configured to dynamically determine an appropriate advertising asset to be integrated into the virtual environment dependent on metadata associated with the placeholder and on metadata associated with available advertising assets. For example, the game or ad server may select an advertising asset for which metadata associated with the advertising asset is compatible with the metadata associated with the placeholder, as described herein. In various embodiments, metadata associated with advertising assets may include values of classification attributes, visual attributes, physical attributes, behavioral attributes, and/or interactivity attributes. Once an appropriate advertising asset is selected in response to a request, it may be returned to the requesting application for integration into the virtual environment when the virtual environment is displayed. The selected advertising asset may in some embodiments include a three-dimensional model of a product or of an advertisement of a product.

In some embodiments, in response to an interaction with an advertising asset, additional information may be provided to the application to be integrated into the virtual environment. For example, following an interaction with an advertising asset, another advertising asset may be presented, a video advertisement may be displayed, a pop-up window may be brought up, an asset model may be subjected to various physics effects (e.g., gravity), or an animation may be run. Such additional assets and/or behaviors may be dynamically determined in response to the interaction with the advertising asset (e.g., in response to a user's in-game character picking up an item or crashing into a billboard).

During execution of an application employing tagged virtual environments, when the application encounters a tagged virtual environment, the embedded instructions may be executed to request an appropriate advertising asset from a game server or ad server. The request may include an indication of the placeholder, values of various placeholder attributes, and/or user-specific or session-specific information, in various embodiments. The application may receive one or more appropriate advertising assets from the game or ad server in response to the request, and may present those assets in the context of the virtual environment. In response to various interactions within the application, additional context-sensitive requests for advertising assets may be communicated to the game or ad server, and additional advertising assets appropriate for the new context may be received and integrated into the virtual environment.

The methods described herein may enable seamless context-sensitive interactivity between users (e.g., game application users) and the advertising assets placed in a virtual environment employed by a game application or a similar user application.

The methods described herein may be implemented as program instructions, (e.g., stored on computer-readable storage media) executable by a CPU and/or GPU, in various embodiments. For example, they may be implemented as program instructions that, when executed, implement a virtual environment authoring application, a game server, an ad server, or a game application, responsive to user input. These applications may be used to perform the methods described herein for dynamic integration of advertisements in virtual environments.

### BRIEF DESCRIPTION OF THE DRAWINGS

FIG. 1 is a flow diagram illustrating a method for tagging a virtual environment, according to one embodiment.

FIGS. 2A and 2B illustrate a graphical user interface of a virtual environment authoring application, according to one embodiment.

FIG. 3 is a flow diagram illustrating a method for dynamically integrating advertisements in a virtual environment, according to one embodiment.

FIGS. 4A-4F and 5A-5C illustrate a graphical user interface at different points during execution of an application employing dynamic integration of advertisements in virtual environments, according to various embodiments.

FIG. 6 illustrates various elements of a virtual environment authoring application and a game/ad server, and other elements that may interact therewith, according to one embodiment.

FIG. 7 illustrates a computer system configured to implement a virtual environment authoring application, a game application, a metadata matching module, and a game/ad server, according to one embodiment.

While several embodiments and illustrative drawings are included herein, those skilled in the art will recognize that embodiments are not limited to the embodiments or drawings described. It should be understood, that the drawings and detailed description thereto are not intended to limit embodiments to the particular forms disclosed, but on the contrary, the intention is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follows are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

A system and method for dynamic integration of advertisements in virtual environments may in some embodiments provide contextual placement of advertising assets into a 3D virtual world. The methods for selection of appropriate advertising assets to be integrated into a virtual environment during runtime may be dependent on context-sensitive metadata associated with placeholders tagged in the virtual environment (e.g., using a virtual environment authoring application), and corresponding metadata associated with various advertising assets. These methods may enable seamless context-sensitive interactivity between users (e.g., game application users) and the advertising assets placed in a virtual environment employed by a game application or a similar user application. In some embodiments, the selection of appropriate advertising assets may be further dependent on user information and/or game session information captured at runtime.

Using the techniques described herein, commercial products may be advertised using advertising assets implemented as 3D models within a 3D game played in a web browser. The 3D models may be tagged with information about various physical attributes and/or behavioral attributes associated with the advertising assets so that they play seamlessly along with such a game, with an interactive movie, or with another similar application. Dynamically integrating 3D advertising assets within a 3D game or a similar application may lead to increased brand recall through the application of animations, lighting of geometry, simulation of physics, and/or the opening of rich media advertisements when these assets are encountered by the user (or the user's in-game character) at runtime. Placing 3D advertising assets inside a virtual 3D world, and integrating attributes such as lighting, physics, animation, and event handling based on user-specific actions may also provide better realism to the captive audience playing games. The techniques described herein may be used to dynamically place advertisements inside 3D games, and to change them in response to differences in user characteristics, the user's environment, the status of the game, the currently available products, the currently available advertising assets for those products, the scope of an advertising campaign, or on other conditions. They may in some embodiments provide a game user with a 360° view of an advertised product inside the virtual world, and may provide the user with additional information about the product in response to user actions indicating an interest in the product or an explicit request for more information.

As noted above, displaying commercial products as 3D models within a 3D game may provide a more realistic user experience in a 3D game than may be provided by static, two-dimensional (2D) advertisements. Because the system may render advertisements dynamically from a database of advertising assets separate from the target game application, an advertiser may deliver the latest advertising assets without any changes needing to be made to the game. In addition, the techniques described herein may allow multiple advertising campaigns to be handled within a single game by allowing different advertising assets to be integrated into the game at different points and in response to various environment-specific, session-specific, or user-specific criteria. Placement of relevant advertising assets based on stored and/or captured metadata may add realism to the audience playing games, while allowing the flexibility of dynamism in placing advertisements inside 3D games.

In various embodiments, advertisements may be served dynamically into a virtual world in the form of images or 3D solid objects. This may be useful for product placement. In current systems, product placement typically requires re-engineering of the virtual world for each product placement, and product placements cannot be changed after publication of a game or a virtual environment thereof. The techniques described herein may provide the dynamic placement of advertisements in a virtual environment with no requirement to re-engineer the virtual environment to change the placements.

For example, a mobile phone company may wish to advertise its latest phone models within a 3D game as soon as they are ready, in order to reach the market. To provide a 360° view, they may create 3D models of these mobile phones using 3D modeling tools. In some embodiments, some or all of the models may be tagged with information indicating the addition of a spotlight above the model for focused illumination. Animation attributes may also be added to the models, in some embodiments. For example, a flip-top model may be tagged with corresponding animation information, which may enable an animation of the phone opening to be displayed in the virtual environment. In some embodiments, a model may be associated with a rich media advertisement that may be displayed when the user clicks on, or otherwise interacts with, the model. In some embodiments, a model of the mobile phone may be associated with a physics property, e.g., so that it may “fall” under gravity when a collision occurs within the virtual environment. Such attribute information may be stored in files that can be converted to an appropriate format supported by various client applications (e.g., game applications) and/or applications hosted on a web server (e.g., a game server or ad server).

The methods described herein may provide, to one or more applications, information about virtual environments, including placeholders for advertisements within the virtual environments. As described herein, adding placeholders for advertising assets to a virtual environment or an item thereof may be referred to as “tagging” the virtual environment or item. The metadata associated with those placeholders may be referred to as tags. In various embodiments, virtual environments may be 3-dimensional virtual worlds as rendered by a computer in real time. The term “placeholders” may be used to refer to locations within the virtual worlds where advertisements may be placed.

Virtual environments may be classified into various categories depending on the type of users they cater to. For example, games may be widely classified as action games, racing games, sport games, puzzles, etc. In some embodiments, placeholders within a virtual environment, and/or the virtual environment itself, may be associated with a classification attribute indicating the type of game, or other application, for which the virtual environment is targeted. There may also be attributes associating a virtual environment, or placeholder thereof, with various sub-classifications. The virtual environment may contain placeholders that are similarly tagged so that relevant assets can be placed within the virtual environments. These placeholders may be inserted into a virtual environment using a virtual environment authoring application, in some embodiments. Available advertising assets may also be tagged with information relating to the asset, such as the type of asset, the behaviors exhibited by the asset, the physical properties of the asset, etc. In order to dynamically place appropriate advertising assets in virtual environments, attributes of placeholders may be compared with attributes of available advertising assets to find a match. For example, if metadata indicates that a placeholder is tagged as a bottled drink, and that the virtual environment is appropriate for a child's game, an advertising asset for a juice-based, non-alcoholic drink may be integrated into the virtual environment, rather than one associated with a new brand of beer.

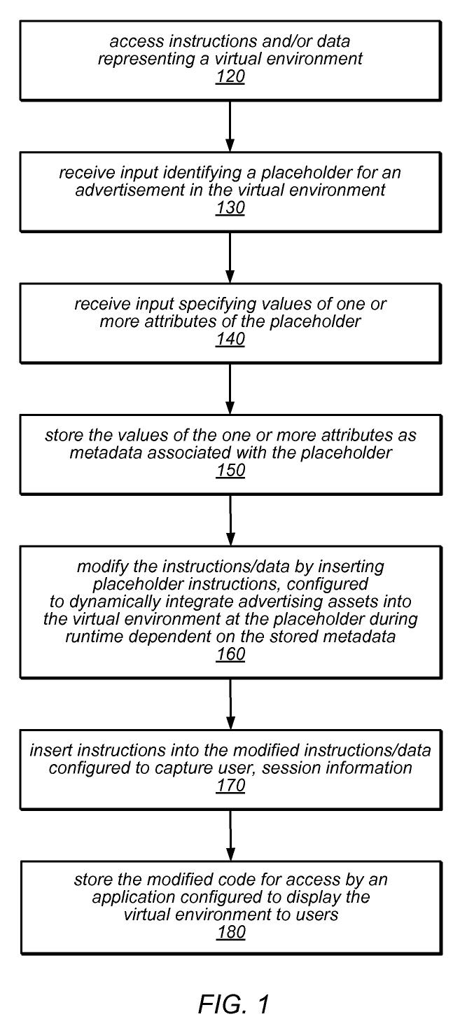

One method of authoring a virtual environment employing the methods described herein is illustrated in FIG. 1. In this example, instructions and/or data representing a virtual environment are accessed by a virtual environment authoring application, as in 120. For example, a developer of a game application or other application employing virtual environments may design a virtual environment within the framework provided by a virtual environment authoring application, and may access instructions and/or data representing a particular “room”, “scene”, or other portion of a virtual environment in order to tag the environment with placeholders for advertisements.

As illustrated in FIG. 1, the virtual environment authoring application may be configured to receive input identifying a placeholder for an advertisement in the virtual environment, as in 130. In some embodiments, placeholders may be added to the virtual environment at the time the virtual environment is being designed (e.g., by a graphic designer). In other embodiments, placeholders may be added to the virtual environment after the initial design of the virtual environment, but before the release of one or more applications employing the virtual environment. For example, a graphic designer may design the visual elements of the virtual environment, and a game designer (or other application designer) may add placeholders for advertisements to the virtual environment at a later time (e.g., during integration of the modules making up a game or other application). In various embodiments, placeholders may be added to an individual element of the virtual environment (e.g., tagging an item depicted in a scene), to a portion of a depicted scene (e.g., designating an area of the image at which an advertising asset may be placed), to a virtual environment being depicted by the virtual environment authoring application (e.g., tagging an image, frame, or scene representing a “bar”, a “house”, etc.), or to the environment itself (e.g., tagging the virtual environment as being applicable to a particular type of game, such as a road race, or for application in a game for children, for adults, or for all ages). In various embodiments, a graphic designer and/or application designer may provide input to the virtual environment authoring application identifying placeholders for advertisements through a graphical user interface (as described in more detail below) or using other input means (e.g., by inserting instructions directly into program code representing the virtual environment through a text editing application).

In the example illustrated in FIG.1, the method may include the virtual environment authoring application receiving input specifying values of one or more attributes of an identified placeholder, as in 140. For example, a graphic designer and/or application designer may provide input to the virtual environment authoring application through a graphical user interface or through a text editing application, in different embodiments. The attributes of the placeholder for which values may be specified may include a classification and/or sub-classification for the target game or application into which the virtual environment may be integrated, a target age group and/or gender of end users (i.e., those who are more likely to view the virtual environment), a classification and/or sub-classification of the image, frame, or scene being tagged, a classification and/or sub-classification of a tagged item in the virtual environment (e.g., an item to which a logo, video, animation, or other advertising asset may be applied and/or with which such assets may be associated), a classification and/or sub-classification of an item to be placed at the location indicated by the placeholder (e.g., a drink, a bottled drink, an adult drink, a candy bar or snack item, a television, a phone, a car, a piece of furniture, a billboard, etc.). In some embodiments, multiple attribute values may be specified for a single placeholder.

In some embodiments, such as that illustrated in FIG. 1, the method may include storing the received attribute values as metadata associated with the placeholder, as in 150. For example, in one embodiment, attribute values may be stored in a database by the virtual environment authoring application and associated with an identifier of the virtual environment and/or an identifier of the placeholder. The stored metadata may be accessible by a game server or ad server, or by an application into which the tagged virtual environment may be integrated at runtime and/or at other times, in various embodiments.

In the example illustrated in FIG. 1, the method may include the virtual environment authoring application (and/or a separate or integrated virtual environment tagging module) modifying the instructions and/or data representing the virtual environment by inserting additional instructions and/or data configured to cause a game/ad server (or similar application) to dynamically integrate one or more appropriate advertising assets into the virtual environment at the placeholder location during runtime, as in 160. In some embodiments, dynamically integrating the advertising assets may be dependent on the stored metadata associated with the placeholder. For example, at runtime, execution of the additional instructions may cause the game application to communicate with the game/ad server to request advertising assets to be placed in the virtual environment at the placeholder, to receive advertising assets from the game/ad server, and to display or otherwise present the advertising assets in the virtual environment.

In some embodiments, additional instructions may be inserted in the instructions/data representing the virtual environment that are configured to cause the capture of attribute values related to the user, game session, or context in which the virtual environment is operating, as in 170. For example, at runtime, execution of these additional instructions may cause the game application to capture and/or communicate to the game/ad server information indicating the user's age or gender, information indicating the current status of the game and/or the user's in-game character (e.g., a number and/or type of points, achievements, or in-game objects a character has accumulated, or a number of times a user or an in-game character has encountered a given virtual environment and/or a given placeholder thereof), information about the location of the user (e.g., the country in which the user is located) or the time of day at the user's location, a skill level of the user, or other context-specific information. These additional instructions may be configured to pass values of such user and/or game session attributes to the game/ad server for use in selecting appropriate advertising assets to be integrated into the virtual environment.

In the example illustrated in FIG. 1, the method may include the virtual environment authoring application storing the modified instructions for subsequent execution, as in 180. For example, in one embodiment, the modified instructions may be stored in a database by the virtual environment authoring application and associated with an identifier of the virtual environment. The stored instructions may be accessible by a game/ad server, and/or by a game application into which the virtual environment may be integrated, at runtime and/or at other times (e.g., as a module or function called by a game application), in various embodiments. In other embodiments, the modified instructions may be inserted directly into program instructions configured to implement a game or other application employing the virtual environment.

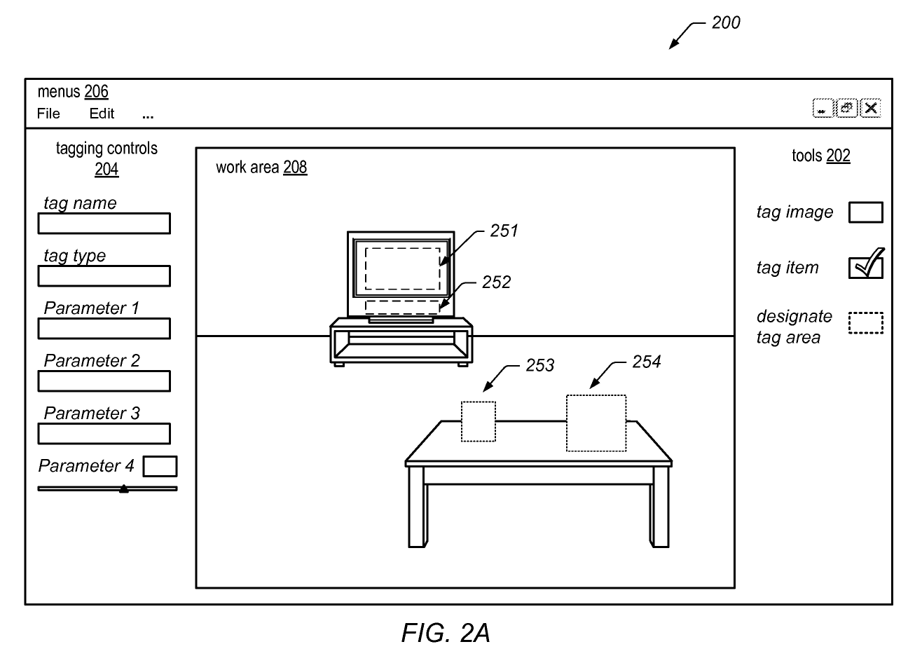

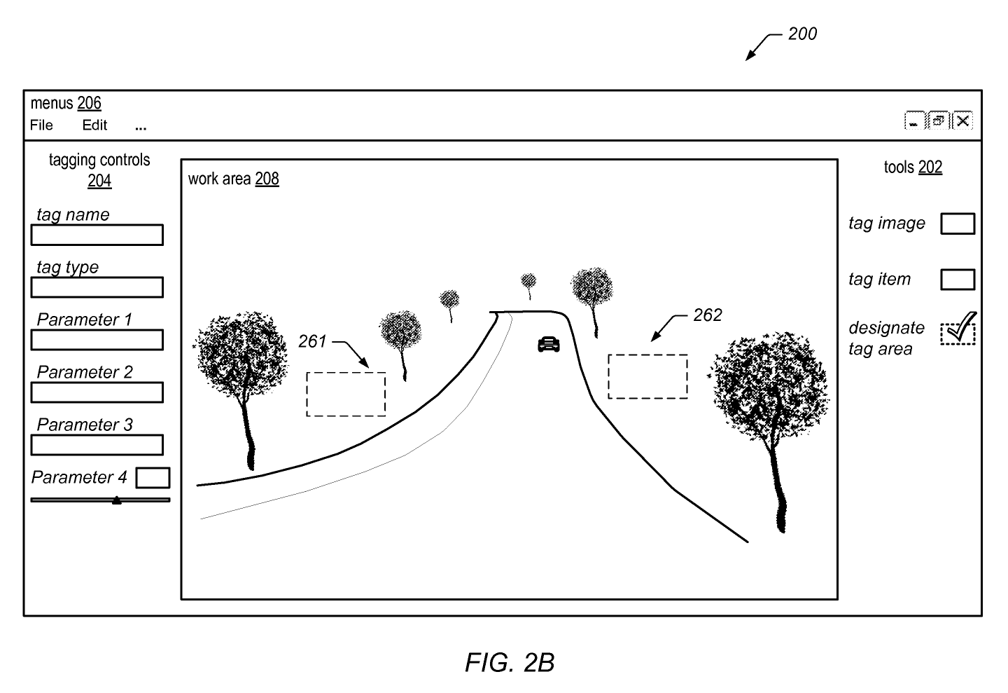

As previously noted, in some embodiments, a virtual environment authoring application may include a graphical user interface through which a graphic designer or application designer may tag a virtual environment and/or specify values of various attributes associated with each tag (i.e., placeholder). FIGS. 2A and 2B illustrate such a graphical user interface, according to various embodiments. For example, FIG. 2A illustrates one embodiment of a user interface of a virtual environment authoring application, as described herein. In this example, a user interface window 200 of the virtual environment authoring application displays various frames that may be visible to a user during a virtual environment tagging operation, according to one embodiment. The user interface illustrated in FIG. 2A is provided as an example of one possible implementation, and is not intended to be limiting. In this example, the display is divided into four regions or areas: menus 206, tagging controls 204, tools 202, and work area 208. Menu area 206 may include one or more menus, for example menus used to navigate to other displays in the virtual environment authoring application, open files, print or save files, undo/redo actions, and so on. In some embodiments, a virtual environment representation (e.g., a file containing image data, metadata, etc., for various scenes or frames) may be identified by the user through the “file” option in menu area 206. This menu item may include, for example, a user-selectable pull-down option for importing images or frames from an identified file.

As illustrated in FIG. 2A, the virtual environment authoring application may provide a user interface including one or more user interface elements whereby a user may select and control various parameters of a tagging operation, as described herein. In this example, user interface elements (e.g., user-modifiable controls such as alphanumeric text entry boxes and slider bars) usable to specify various parameters of a tagging operation are displayed in a frame in the tagging controls area 204 along the left side of window 200. For example, in various embodiments, the user may be able to provide inputs specifying a tag name, a tag type, or values of any of various parameters of a tagging operation, including, but not limited to: application, environment, or scene classification information, age and/or gender appropriateness, tagged item classification information, or information about the type and/or attributes of an advertising asset to be inserted in a designated location in the virtual environment.

In some embodiments, a user may be prompted to provide one or more of the inputs described above in response to invoking a tagging operation of the virtual environment authoring application. In other embodiments, the virtual environment authoring application may provide default values for any or all of these inputs. In still other embodiments, the virtual environment authoring application may be configured to automatically determine the values of various parameters of the tagging operation, dependent on other known parameter values (i.e. metadata) associated with the virtual environment or scene/frame thereof In one such embodiment, the virtual environment authoring application may be configured to automatically determine a set of default values for one or more parameters of the tagging operation dependent on characteristics of similar tagged scenes and/or items. For example, if an item depicted in a previously tagged scene of the virtual environment has been tagged with an attribute value of “alcoholic beverage”, a similar item in a scene currently being tagged may automatically be associated with the attribute value “alcoholic beverage.” In some embodiments, the user may be allowed to override one or more default values for inputs of tagging operation using an interface similar to that illustrated in FIG. 2A.

In the example illustrated in FIG. 2A, user interface elements (e.g., radio buttons) usable to invoke various virtual environment authoring tools (e.g., tools usable to tag the entire image currently being displayed, to tag an item depicted in the currently displayed image, or to designate an area of the currently displayed image to be tagged) are displayed in a frame in the tools area 202 along the right side of window 200. In various embodiments, a virtual environment authoring application that supports tagging operations, as described herein, may provide user interface elements for controlling various aspects of other virtual environment authoring operations, such as 3D image editing operations. In such embodiments, the user interface of the virtual environment authoring application may include tools not shown in FIG. 2A to support these operations, such as drawing tools, or an “undo” tool that undoes the most recent user action in work area 208.

As illustrated by the example in FIG. 2A, a 3D image, frame, or scene of the virtual environment may be displayed in work area 208 in a large central frame in the center of window 200. In this example, work area 208 is the area in which an image or scene being tagged and/or otherwise modified is displayed as various virtual environment authoring operations are performed. In various embodiments, and at various times during tagging operation and/or another virtual environment authoring operation, work area 208 may display all or a portion of a tagged 3D image, frame, or scene or an intermediate 3D image, frame, or scene representing a tagging operation in progress.

In the example illustrated in FIG. 2A, work area 208 displays a 3D scene of a living room of a virtual environment. In this example, the living room has been tagged with four placeholders (indicated by 251-254) using the virtual environment authoring application. Element 251 is a placeholder located in the screen area of a television. This placeholder may have been inserted to tag the television screen using the “tag item” tool in tool area 202, and one or more attributes may have been specified for the placeholder using one or more of tagging controls 204. Various types of advertising assets such as 3D still images or videos, may be inserted at the position indicated by this placeholder at runtime, using the methods described herein. Similarly, element 252 is a placeholder at which a logo for a particular television brand or model may be placed at runtime. Element 253 indicates an area within the living room at which a particular item or item type may be placed. This placeholder may have been inserted to tag this area of the image using the “designate tag area” tool in tool area 202, and one or more attributes may have been specified for the placeholder using one or more of tagging controls 204. In this example, the placeholder indicated by 253 may be associated with an attribute identifying it as a placeholder for a bottled drink. Similarly, element 254 may be a placeholder associated with an attribute identifying it as a placeholder for a telephone. In this example, at runtime, advertising assets having metadata compatible with the metadata for these placeholders may be inserted in the locations indicated as 253 and 254.

While FIG. 2A shows various elements in tools 202 and tagging controls 204 as alphanumeric text entry boxes, radio buttons, and slider bars, other types of user interface elements, such as pop-up menus, pull-down menus, dials, or other user-modifiable controls may be used for specifying various parameters of a tagging operation or other virtual environment authoring operation of the virtual environment authoring application, in other embodiments.

The graphical user interface illustrated in FIG. 2B is similar to that illustrated in FIG. 2A. In this example, an image or frame of an outdoor scene, such as may be employed in a road racing game or similar application, is depicted in work area 208. In this example, elements 261 and 262 indicate areas of the scene at which advertising assets may be placed at runtime. These placeholders may have been inserted to tag respective areas of the image using the “designate tag area” tool in tool area 202, and one or more attributes may have been specified for each placeholder using one or more of tagging controls 204. For example, each of the placeholders indicated as elements 261 and 262 may be associated with an attribute identifying it as a billboard. In some embodiments, additional attributes may be associated with each of the placeholders, e.g., indicating that they are appropriate for placement of 3D still images, 3D videos, interactive advertisements, or other types of advertising assets.

Advertising campaigns may provide advertising assets relating to products being advertised to a service provider (e.g., one operating an on-line game server or ad server) for integration into relevant virtual environments. In various embodiments, a graphical user interface similar to that illustrated in FIGS. 2A and 2B may be provided to an advertiser, or an agent thereof, to tag advertising assets with various attributes, such as those described herein. This information (e.g., the asset metadata, or “tags” associated with an asset) may be attached to, or otherwise associated with, each of the advertising assets by the advertiser before delivery, or by an agent of the advertiser after delivery, to describe the asset and/or its behavior within a virtual environment. The information may be provided based on the same taxonomy used in tagging virtual environments and/or items thereof. Note that the methods described herein do not pre-suppose any particular method for generating or attaching tags to the advertising assets. However, they may assume that this information exists and that it is attached appropriately. As described above, virtual environments within which the assets are to be placed may also have information attached to them describing the context of the virtual environment or any sub-region in a virtual world.

The nouns, adjectives and verbs used to describe the virtual environment and the advertising assets may be together known as the taxonomy, examples of which are described in more detail below. The methods described herein may presume that taxonomy exists for physical attributes, interactivity attributes, visual attributes, environment attributes, etc., for a game. However, the method outlined herein may be independent of the particular taxonomy employed. In other words, the methods described herein may be applicable to any taxonomy, though its efficiency in placement of advertisements may deteriorate if classifications are not appropriate. As noted above, metadata may be expressed using terms from the taxonomy. As with the taxonomy, the methods may not care how the metadata came to be, only that it exists.

As described herein, tagging of virtual environments and of placeholders within virtual environments may provide contextual information about the types of advertisements that could be potentially placed into the virtual environments. As an example, consider the following:
In a bar in a virtual world, one would not advertise for milk. The environment for such a world may be tagged as a bar. A placeholder within the bar may be tagged as an alcoholic beverage, a bottled beverage, etc. In some embodiments, multiple tags may be placed on a single object. These tags may enable a server (e.g., a game server or ad server) to enact a search to provide the best fit for advertisements to place within the bar.

Placeholders and advertising assets may have associated tags that provide information relating to the size, orientation and/or material of an object (e.g., attributes of a product represented by a 3D model, or constraints on advertising assets that may be placed in a virtual environment), in some embodiments. Information about such attributes may enable an advertising asset to be displayed with the correct form-factor in the context of the virtual environment. Together, the various attributes described herein may provide for dynamic, contextual placement of advertising assets, based on environmental and product considerations.

In various embodiments, the methods described herein may degrade gracefully. For example, in a prehistoric-type virtual environment, common modern day objects may be depicted in a “stone-age” fashion. In this virtual environment, a stone-age phone may be depicted sporting a modern phone company logo that could be used to enhance brand-recall. In this example, tagging the stone-age phone as a communication object and tagging the virtual environment within which the communication device exists with an era of “stone-age”, may enable a game/ad server to provide the correct visual depiction of a phone, if one exists, while still incorporating contemporary advertising assets. This may allow the system to provide a quality of service for product placement which can degrade gracefully when less than desirable contexts are encountered, rather than ignoring them.

As noted above, the nouns, adjectives, and verbs used to describe virtual environments and advertising assets may together be known as the taxonomy. The first two may describe properties of an advertising asset, while the last one may describe its behavior. When the taxonomy is used to describe a virtual environment or advertising asset, the description is referred to herein as metadata. As noted above, the method may pre-suppose the existence of a hierarchical classification of the taxonomy.

In some embodiments, 3D files (e.g., files having one of the following file formats: .obj, .w3d, .bae, .fbx, .ma, .mb, etc.) may contain various advertising assets. These files, and/or assets thereof, may be loaded dynamically from a resource located using a uniform resource locator (URL) according to an http or https uniform resource identifier scheme, and inserted at pre-defined positions in a game. The 3D models of the advertising assets may be tagged with information about attributes/behaviors so that they play seamlessly along with a game or other application. In various embodiments, one or more of the following attributes may be associated with a 3D model:
An attribute indicating lighting of the mesh geometry to capture the gamer's interest.
An attribute adding one or more 3D physics properties for actions that are initiated in response to game events. For example, playing an animation after a collision within the game, or simulating an explosion effect when a 3D object collides with a 3D advertising asset.

When an advertising asset needs to be placed into a virtual environment, the tags of the virtual environment and placeholders may be consulted and compared. In some embodiments, a search mechanism may unify the requirements of the virtual environment (as expressed by its tags) and the requirements of the advertising asset (as expressed by the assets' tags). The search mechanism may further merge information relating to a user's context (such as the country of the user, the time of day at the user's location, etc.). The unification may result in the selection of appropriate advertising assets to be served in the virtual environment.

These selected assets may then be dynamically loaded into the virtual environment, which may be configured to interact with the placed assets. The attributes/behaviors that the downloaded asset may (or should) perform may in some embodiments be dynamically attached to the asset based on the metadata. This may enable the user to seamlessly interact with the placed asset.

In some embodiments, when the virtual environment encounters a placeholder for an asset, it may place a request for an asset to the game/ad server, e.g., using an http or https scheme, and the request may include classification information. This information may be mapped with the metadata of the available advertising assets, and the most relevant advertising asset(s) may be dynamically downloaded and displayed within the virtual environment.

The behavior of the placed asset within the virtual world may be dynamically determined by reading the metadata information attached to it. For example, animations and physical attributes may be dynamically attached to an asset and may specify the appearance and/or behavior of the asset within the virtual environment. For example, continuing with the bar example in the virtual environment described above, a user may be allowed to interact with the object (bottle) by picking it up. In this case, the weight matters and so does the smoothness. The user may be allowed to open it, and if it is champagne, the champagne may gush out! If the user drops it, and if the bottle is made of glass, according to another piece of metadata, it may shatter. These are examples of physical properties which can be changed for each dynamic product placement, and which may be enacted by state-of-the-art physics integrated into the game application, in some embodiments.

In various embodiments, advertising assets may have additional interaction mechanisms associated with them. For example, hovering over or clicking on an advertising asset in the virtual environment may bring up a rich user interface with an additional interaction palette. This may be used to dispense further information regarding the product being advertised within the virtual environment, seamlessly, without interfering with the user experience, and may be integrated with environment-specific actions. Tags may be used to provide information ranging from default information (to be used when no contextual match exists) to details to be presented in valid contexts. The system and methods described herein, therefore, may provide user interaction with advertisements that seamlessly integrate into the virtual environment based on the context.

In one example, the methods described herein may be applied to a treasure hunt game, in which the player visits various rooms and picks up gadgets placed at locations within each room. At runtime, mobile phone 3D advertising assets that are hosted by the game/ad server may be downloaded by the game and placed at pre-defined locations within each room. Spotlights may be added at runtime for all the 3D advertising assets, in some embodiments. Any corresponding animations for each model may be assigned at runtime to each model. Physics attributes may also be applied so that a mobile phone that is placed on a table falls under gravity when another object collides with it. In this example, the player may be provided with a 360° view of one or more 3D mobile phone models within the game. The next time the user plays the game, the user may see a different mobile phone model in the same position that the advertiser has provided to the game/ad server.

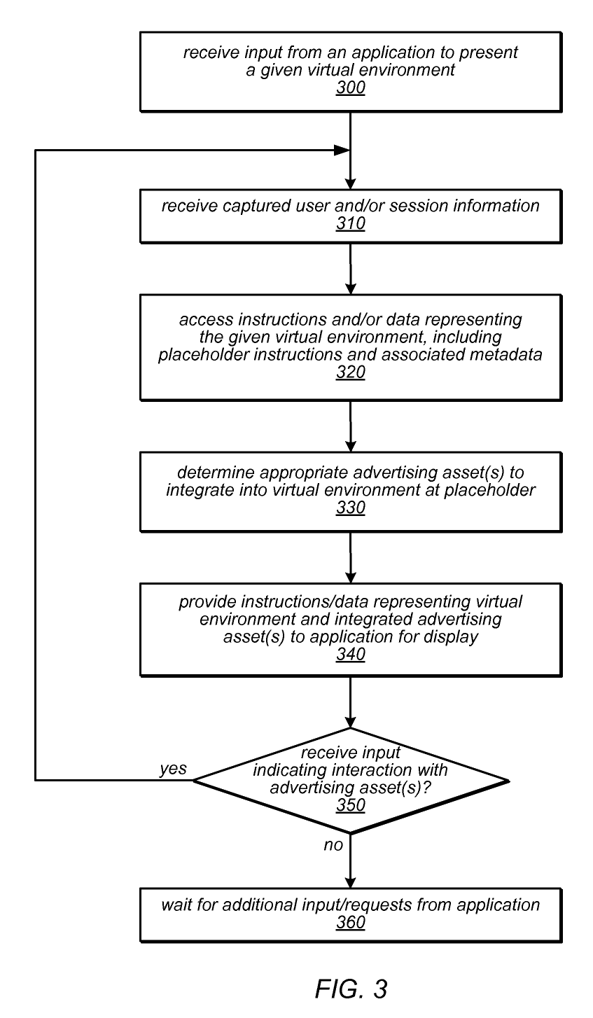

One embodiment of a method for dynamically integrating advertisements in a virtual environment is illustrated in FIG. 3. In this example, the method may include a game/ad server, or similar component, receiving input from a game application (or other client application) to present a given virtual environment, as in 300. For example, the game/ad server may receive input indicating that the user's character has chosen to “enter the living room” or “begin road race”. In another example, the game/ad server (or an advertising asset selection module thereof) may receive a request for advertising assets (e.g., an http request, as described above) from a game application in response to such user input. As illustrated in FIG. 3, the method may include receiving captured user and/or session information, as shown in 310 and described above. For example, the game/ad server (or an advertising asset selection module thereof) may receive information about the user from a browser application configured to capture such information or from a cookie, or may receive information about the status of a game session and/or of the user's in-game character from the game application, in various embodiments.

As illustrated in FIG. 3, the method may include accessing instructions and/or data representing the virtual environment, as in 320, including any placeholder instructions (tags), and metadata associated therewith, that were stored in a database when the virtual environment was originally designed or subsequently tagged (e.g., prior to release within the game application). The method may include the game/ad server (or an advertising asset selection module thereof) determining one or more appropriate advertising assets to be integrated into the virtual environment at locations indicated by the placeholders, as in 330. For example, the method may include a metadata matching module comparing metadata associated with the placeholders and/or captured user or session information to metadata associated with various advertising assets to select one or more particular advertising assets to be integrated into the virtual environment, as described herein.

As illustrated in FIG. 3, the method may in some embodiments include generating and/or otherwise providing instructions and/or data representing the virtual environment, including the selected advertising assets integrated therewith, to the game application for display, as in 340. For example, a game/ad server hosting an on-line game may be configured to integrate the selected advertising asset(s) into the code representing the virtual environment as part of providing the virtual environment to a user (e.g., via a client's web browser). In other embodiments, the method may include providing instructions and/or data representing the selected advertising asset(s) to a client game application for integration with the virtual environment by the game application itself. For example, the game/ad server (or an advertising asset selection module thereof) may be configured to access stored data and/or instructions executable to display a 3D image, animation, or video of an appropriate advertisement or advertised item and to provide the data and/or instructions to the game application for execution within the current context of the game application (e.g., to “fill in” a placeholder in the virtual environment with a 3D image, animation, or video of the advertisement or advertised item).

As described herein, in some embodiments, advertising assets may be associated with various interactivity attributes or other behavioral attributes. In the example illustrated in FIG. 3, the method may include receiving input indicating that an interaction has taken place between a user (or a user's in-game character), and a placed advertising asset, shown as the positive exit from 350. In such embodiments, in response to an indication of interaction between the user and an advertising asset, the method may include receiving additional captured information about the user and/or game session, shown as the feedback from 350 to 310, and a repeat of the operations illustrated as 320-340 to provide new instructions/data to the application or client browser for integration/display. For example, if a user's in-game character picks up a tagged item in the virtual environment, clicks on a tagged item or area, or hovers over a tagged item or area, the method may include the game/ad server (or an advertising asset selection module thereof) determining additional advertising assets matching metadata associated with or the placeholder for the tagged item or area (e.g., additional information about the item) that should be presented to the user (e.g., based on interactivity attributes associated with the placeholder), and providing them to the game application as instructions and/or data to be displayed. In some embodiments, in response to such an interaction, a client game application may be configured to request new or additional advertising assets from a game/ad server, e.g., based on interactivity attributes associated with the placeholder. In the example illustrated in FIG. 3, the game/ad server (or an advertising asset selection module thereof) may be configured to wait for additional inputs or advertising asset requests from the game application, and to repeat the operations illustrated in FIG. 3 in response to receiving additional inputs or requests, as in 360.

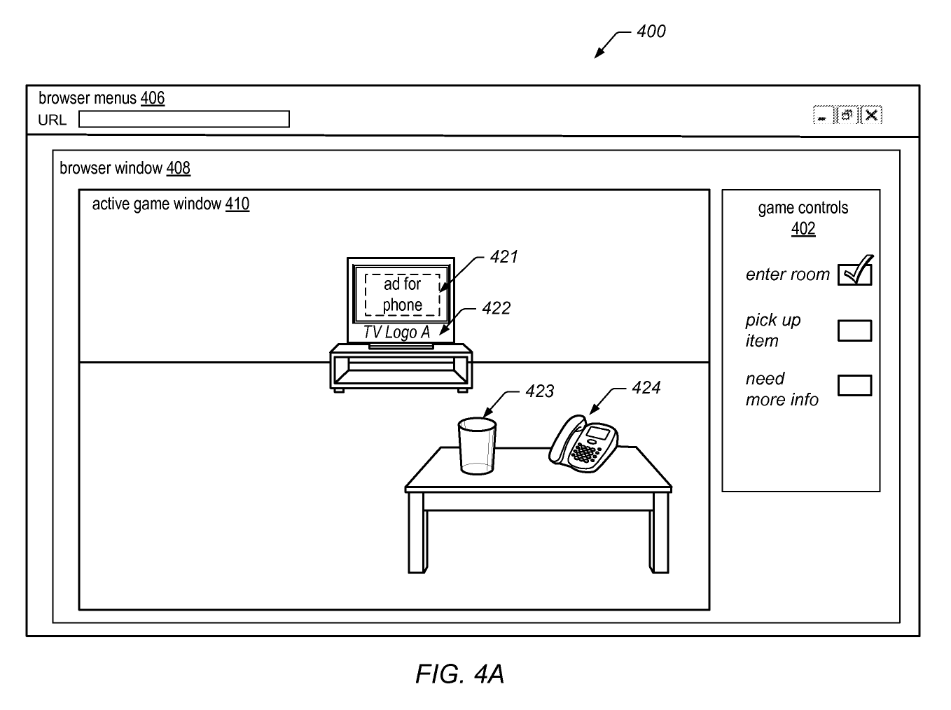

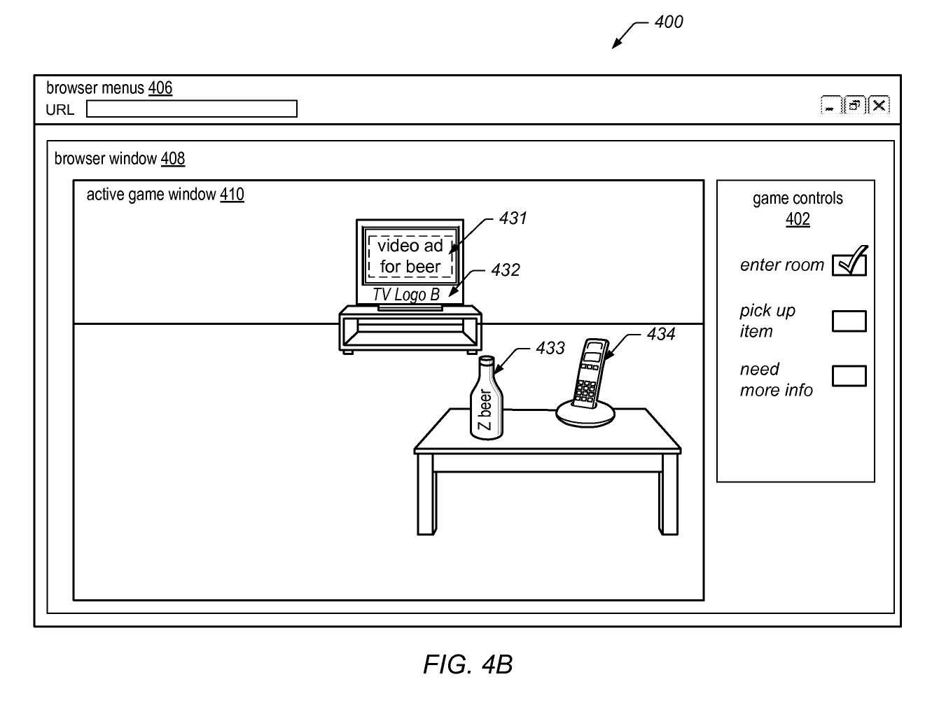

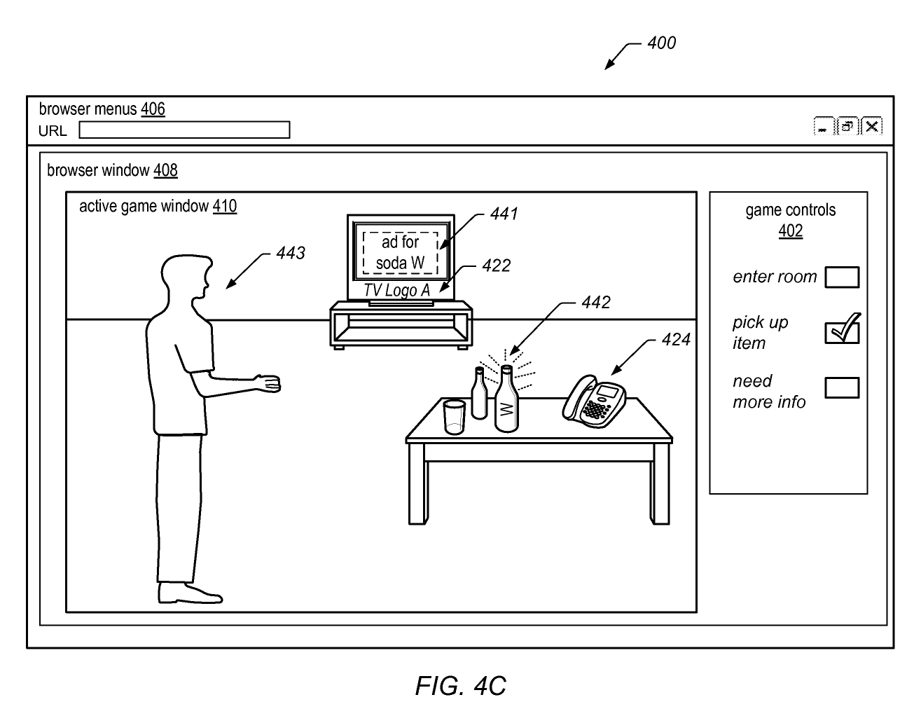

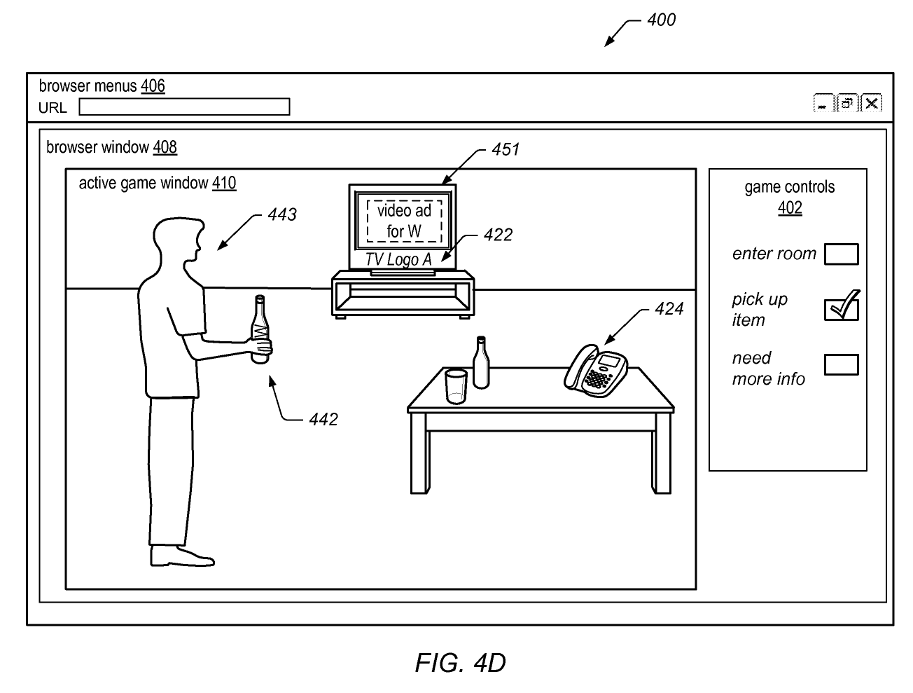

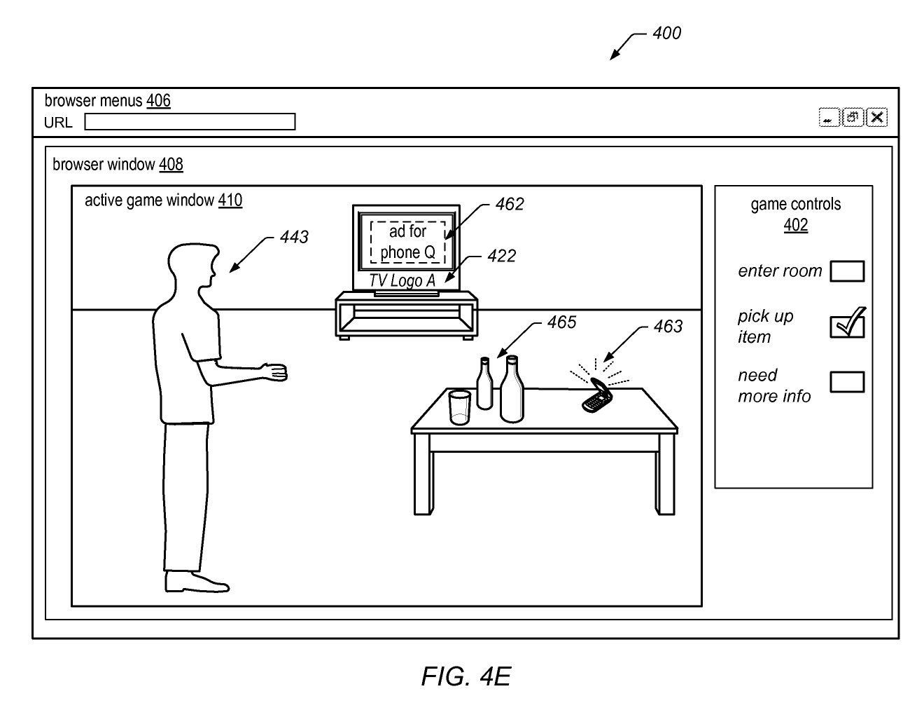

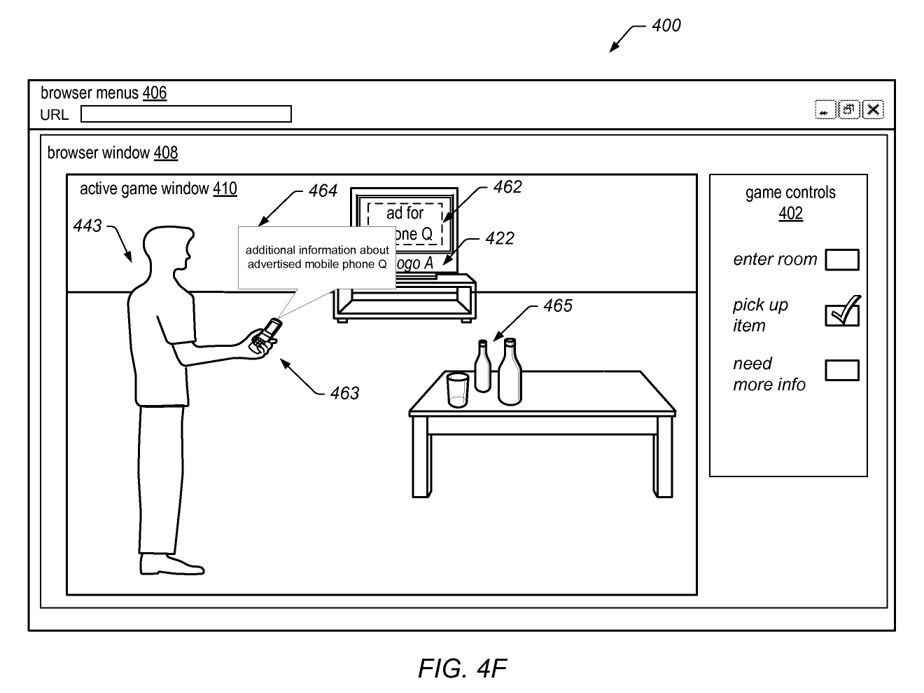

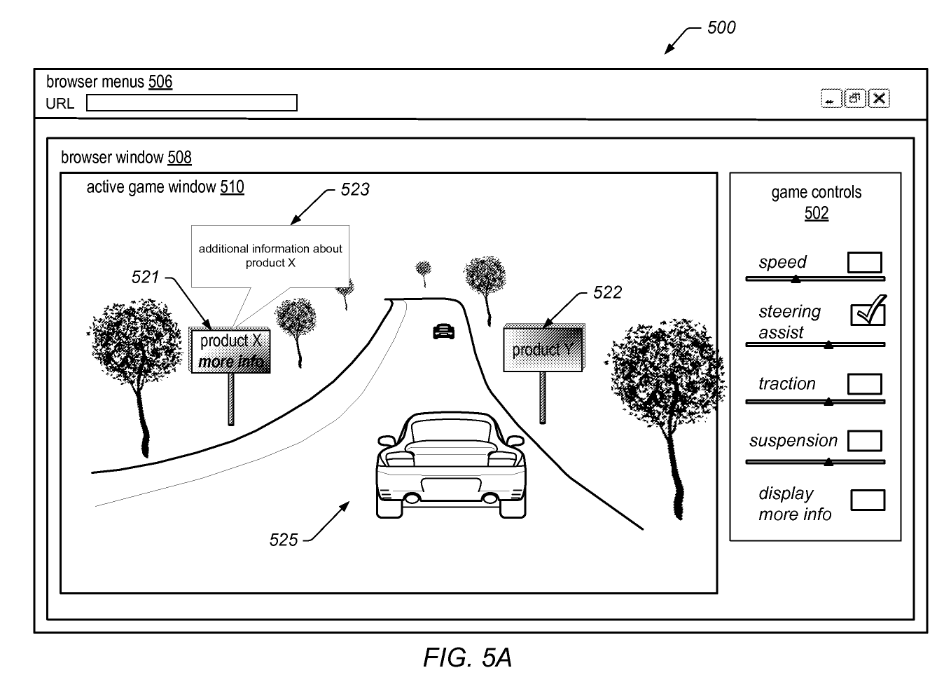

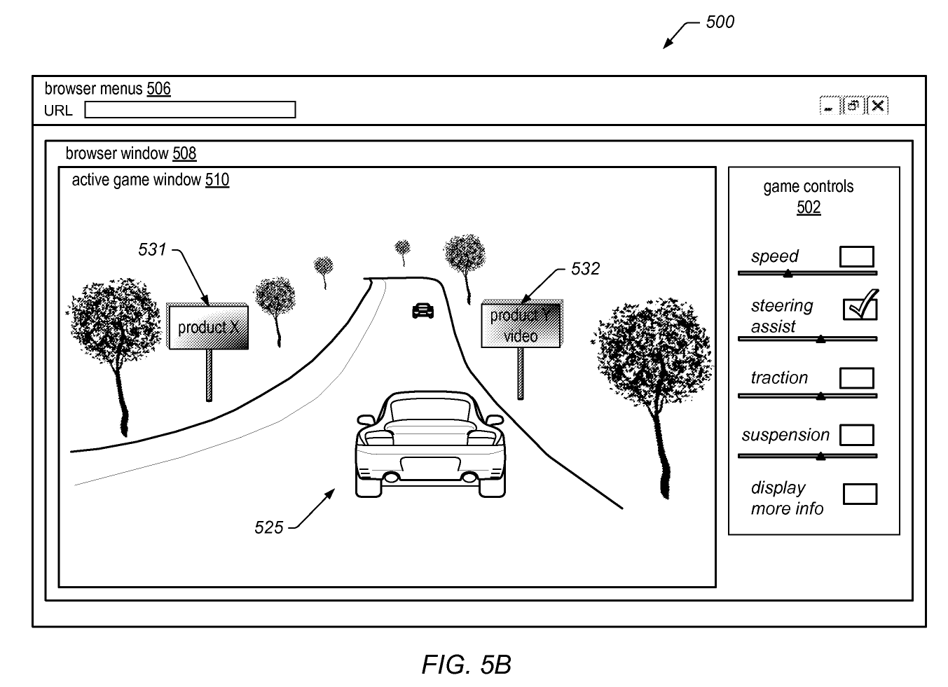

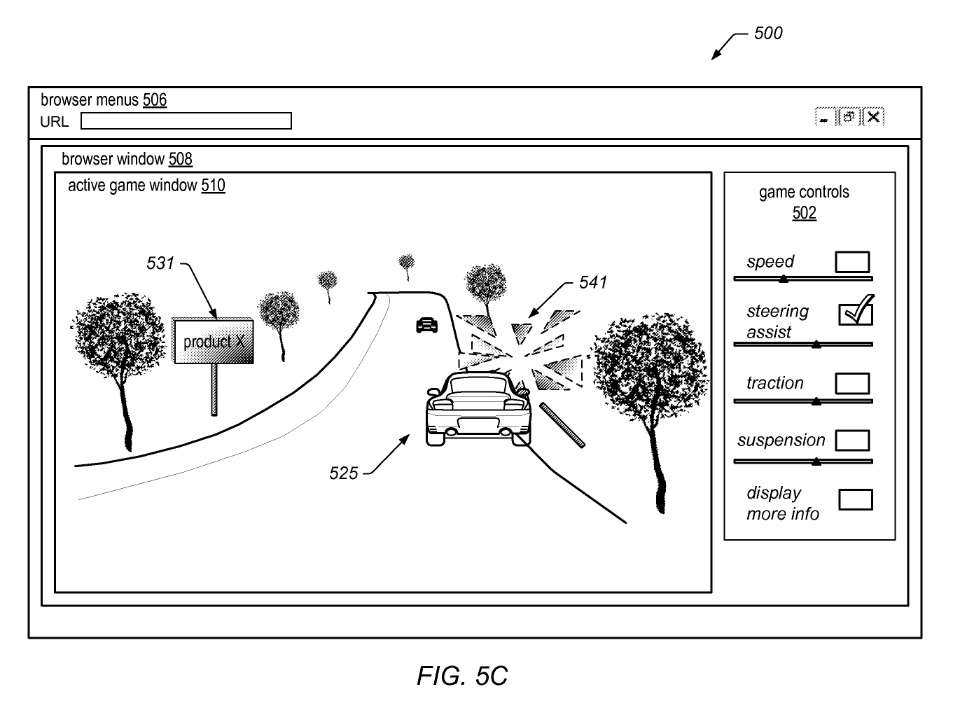

The system and methods for dynamic integration of advertisements in a virtual environment described herein may be further illustrated by way of the example screen shots illustrated in FIGS. 4A-4F and 5A-5C. These figures illustrate the inputs to and results of the application of the methods described herein, according to various embodiments. FIG. 4A illustrates a user interface window 400 employed by a user to play an on-line 3D game. In this example, user interface window 400 displays various frames that may be visible to a user while playing the 3D game, according to one embodiment. The user interface illustrated in FIG. 4A is provided as an example of one possible implementation, and is not intended to be limiting. In this example, the display is divided into four regions or areas: browser menus 406, browser window 408, game controls 402, and active game window 410. Menu area 406 may include one or more menus, for example menus used to navigate to other displays in the user interface, open files, print or save files, undo/redo actions, and so on. In some embodiments, the on-line 3D game may be identified by the user by specifying the URL of a particular game server in menu area 406 through a text entry box. In some embodiments, this menu item may include, for example, a user-selectable pull-down option for selecting the URL of a favorite or recently-played game.

As illustrated in FIG. 4A, the browser window 408 may provide a user interface including one or more user interface elements whereby a user may select and control various aspects of the 3D game. In this example, user interface elements (e.g., user-modifiable controls such as alphanumeric text entry boxes, radio buttons, and slider bars) usable to specify various in-game operations are displayed in a frame in the game controls area 402 along the right side of browser window 408. For example, in various embodiments, the user may be able to provide inputs specifying that the user's in-game character should enter a room or pick up an item. As shown in FIG. 4A, in some embodiments, the user may be able to provide inputs requesting more information (e.g., for an advertised item that the in-game character picks up, or for an item or advertisement over which the user's cursor hovers).

In this example, active game window 410 displays a 3D image of a living room in a virtual environment, similar to that illustrated in the virtual environment tagging example of FIG. 2A. In this example, placeholder 251 of FIG. 2A has been replaced by an advertisement for a phone, indicated as element 421, and placeholder 252 of FIG. 2A has been replaced by a logo for a television of brand A, indicated as element 422. In addition, placeholder 253 of FIG. 2A has been replaced by an image of a glass of milk (shown as 423), while placeholder 254 of FIG. 2A has been replaced by an image of a phone 424 (which may correspond to the phone being advertised at 421). In some embodiments, the selection of the glass of milk for placeholder 251 may be dependent on captured information indicating that the user is a child, or on captured or stored information indicating that the game may be targeted to children. In the example illustrated in FIG. 4A, the virtual living room may have been presented to the user in response to the user's selection of the action “enter room” in game controls 402.

Active game window 410 of FIG. 4B illustrates a second virtual living room similar to that illustrated in the virtual environment tagging example of FIG. 2A. In this example, placeholder 251 of FIG. 2A has been replaced by a video advertisement for a beer, indicated as element 431, and placeholder 252 of FIG. 2A has been replaced by a logo for a television of brand B, indicated as element 432. In some embodiments, the selection of the beer advertisement for placeholder 251 may be dependent on captured information indicating that the user is of legal drinking age in the country in which the game is being played, or on captured or stored information indicating that the game is targeted to adults. In addition, placeholder 253 of FIG. 2A has been replaced by an image of a bottle of beer Z (shown as 433). In this example, beer Z may correspond to the beer being advertised at 431. In the example illustrated in FIG. 4B, placeholder 254 of FIG. 2A has been replaced by an image of a cordless phone 434. In this example, the virtual living room may have been presented to the user in response to the user's selection of the action “enter room” in game controls 402.

Active game window 410 of FIG. 4C illustrates another virtual living room similar to that illustrated in the virtual environment tagging example of FIG. 2A. In this example, placeholder 251 of FIG. 2A has been replaced by an advertisement for a soda W, indicated as element 441, and placeholder 252 of FIG. 2A has been replaced by a logo for a television of brand A, indicated as element 422. In some embodiments, the selection of the soda advertisement for placeholder 251 may be dependent on captured information indicating that the user is a young adult, but is not of legal drinking age in the country in which the game is being played, or on captured or stored information indicating that the game is targeted to teens. Placeholder 253 of FIG. 2A has been replaced in FIG. 4C by an image of a bottle of soda W (shown as 442), corresponding to the soda being advertised at 441. In the example illustrated in FIG. 4C, placeholder 254 of FIG. 2A has again been replaced by an image of phone 424. In this example, the virtual living room may have been presented to the user in response to the user's selection of the action “enter room” in game controls 402, and at the point depicted in active game window 410, the user's in-game character 443 is depicted in the living room.

In the example illustrated in FIG. 4C, the image of the bottle of soda W (442) has been lighted, e.g., in accordance with a physical or behavioral attribute (e.g., a lighting attribute) associated with advertising asset 442 or with placeholder 253, in an attempt to attract the attention of the user. In some embodiments, a physical or behavioral attribute of an advertising asset may be presented in response to user interaction with the asset or placeholder, such as moving the in-game character into the room or close to the advertising asset itself. In this example, the user has selected “pick up item” from the list of game controls 402 in response to noticing the lighted image of soda bottle W (442). Active game window 410 of FIG. 4D illustrates the same scene as that illustrated in FIG. 4C following implementation of the selected action “pick up item.” In this example, the soda bottle 442 was picked up by the user's in-game character 443 in response to selection of this action while the image of the soda bottle 442 was lit up in the virtual environment. In response to character 443 picking up soda bottle 442, a video advertisement for soda W is played on the television, shown as 451. The playing of the video advertisement may be dependent on an interactivity attribute associated with the advertising asset 442 (the 3D model of a soda bottle) or with placeholder 253. In other embodiments, the user may click on or hover over an element in the virtual environment to select it for various actions (e.g., dependent on various physical, behavioral, and/or interactivity attributes associated with advertising asset 442 or placeholder 253).

Active game window 410 of FIG. 4E illustrates another virtual living room similar to that illustrated in the virtual environment tagging example of FIG. 2A. In this example, placeholder 251 of FIG. 2A has been replaced by an advertisement for a mobile phone Q, indicated as element 462, and placeholder 252 of FIG. 2A has again been replaced by a logo for a television of brand A, indicated as element 422. In some embodiments, the selection of the particular phone advertisement for placeholder 251 may be dependent on captured information indicating that the user is a young adult and on captured information indicating the country in which the game is being played (e.g., a country in which phone Q is available), or on captured or stored information indicating that the game is targeted to teens and young adults. Placeholder 253 of FIG. 2A has been replaced in FIG. 4E by an image of three generic bottles (shown as 465), since no bottled drinks are included in a current ad campaign, in this example. In the example illustrated in FIG. 4E, placeholder 254 of FIG. 2A has been replaced by an image of mobile phone (e.g., advertising asset 463, a 3D model of a mobile phone), which may correspond to mobile phone Q being advertised at 462. In this example, the virtual living room may have been presented to the user in response to the user's selection of the action “enter room” in game controls 402, and at the point depicted in active game window 410, the user's in-game character 443 is depicted in the living room.

In the example illustrated in FIG. 4E, the image of the mobile phone Q (asset 463) has been lighted, e.g., in accordance with a physical or behavioral attribute associated with advertising asset 463 or with placeholder 254, in an attempt to attract the attention of the user. In another example, in response to user interaction with mobile phone Q (asset 463), such as moving the in-game character 443 into the room or close to the table on which the phone sits, an audio advertising asset (e.g., a ring tone) may be presented to the user in an attempt to attract the user's attention. In this example, the user has selected “pick up item” from the list of game controls 402 in response to noticing the lighted image or audio advertising asset for mobile phone Q (asset 463).

Active game window 410 of FIG. 4F illustrates the same scene as that illustrated in FIG. 4E following implementation of the selected action “pick up item.” In this example, the mobile phone was picked up by the user's in-game character 443 in response to selection of this action while the image of the mobile phone was lit up (or while the ring tone was playing) in the virtual environment. In other embodiments, the user may click on or hover over an element in the virtual environment to select it for various actions, according to various physical, behavioral, and/or interactivity attributes associated with the element or its corresponding placeholder. In the example illustrated in FIG. 4E, in response to the in-game character 443 picking up the mobile phone, an additional advertising asset 464 is presented to the user in the form of a pop-up window displaying information about mobile phone Q. In other embodiments, in response to picking up or otherwise selecting an advertised item in a virtual environment, other types of advertising assets may be presented to the user, including video assets, audio assets, interactive windows displayed within active game window 410, additional browser windows separate from browser window 408, hyperlinks to product web pages or product ordering screens, etc.

FIG. 5A illustrates a user interface window 500 employed by a user to play a different on-line 3D game, in this case a road racing game. In this example, user interface window 500 displays various frames that may be visible to a user while playing the 3D game, according to one embodiment. The user interface illustrated in FIG. 5A is provided as an example of one possible implementation, and is not intended to be limiting. In this example, the display is divided into four regions or areas: browser menus 506, browser window 508, game controls 502, and active game window 510. Menu area 506 may include one or more menus, for example menus used to navigate to other displays in the user interface, open files, print or save files, undo/redo actions, and so on. In some embodiments, the on-line 3D game may be identified by the user by specifying the URL of a particular game/ad server in menu area 506 through a text entry box. In some embodiments, this menu item may include, for example, a user-selectable pull-down option for selecting the URL of a favorite or recently-played game.

As illustrated in FIG. 5A, the browser window 508 may provide a user interface including one or more user interface elements whereby a user may select and control various aspects of the 3D game. In this example, user interface elements (e.g., user-modifiable controls such as alphanumeric text entry boxes, radio buttons, and slider bars) usable to specify various in-game operations are displayed in a frame in the game controls area 502 along the right side of browser window 508. For example, in various embodiments, the user may be able to provide inputs specifying control values for the user's in-game character 525 (in this case, a car). As shown in FIG. 5A, in some embodiments, the user may be able to provide inputs requesting more information (e.g., for an advertised item that the in-game character encounters, or for an item or advertisement over which the user's cursor hovers).

In this example, active game window 510 displays a 3D image of an outdoor scene in a virtual environment, similar to that illustrated in the virtual environment tagging example of FIG. 2B. In this example, placeholder 261 of FIG. 2B has been replaced by an interactive 3D image of a billboard advertising a product X, indicated as advertising asset 521 (a 3D model of the billboard), and placeholder 262 of FIG. 2B has been replaced by a 3D image of a billboard advertising a product Y, indicated as advertising asset 522 (a 3D model of the billboard). In some embodiments, the selection of the products advertised on the billboards corresponding to placeholders 261 and 262 may be dependent on captured information about the user and/or the country in which the game is being played, or on captured or stored information indicating that the game may be targeted to children, teens, young adults, or adults, in addition to any metadata specified for each of these placeholders (e.g., indicating that an advertisement for a car, an adult beverage, or a television program should be placed in those locations). In the example illustrated in FIG. 5A, the virtual outdoor scene may have been presented to the user in response to the user's selection of an action “begin road race”, “turn left”, or similar (not shown) in game controls 502.

In the example illustrated in FIG. 5A, an additional advertising asset (pop-up window 523) has been presented to the user in response to the user clicking on, hovering over, or otherwise selecting the “more info” section of the advertising asset at 521, or the user's in-game character (car 525) driving past this billboard, dependent on one or more physical, behavioral, and/or interactivity attributes associated with advertising asset 521 or placeholder 261.

Active game window 510 of FIG. 5B illustrates a second outdoor scene similar to that illustrated in the virtual environment tagging example of FIG. 2B. In this example, placeholder 261 of FIG. 2B has been replaced by a static 3D image of a billboard advertising a product X, indicated as element 531, and placeholder 262 of FIG. 2B has been replaced by a 3D image of a billboard displaying a video advertising a product Y, indicated as element 532.

Active game window 510 of FIG. 5C illustrates the same scene as that illustrated in FIG. 5B, following an interaction between the user's in-game character (car 525) and advertising asset 532. In this case, the interaction involves the car 525 crashing into the billboard 532 that advertises product Y. In this example, an interactive or behavioral attribute of advertising asset 532 may specify that upon a collision with a user's in-game character, the advertising asset should be replaced by a video depicting the explosion of the advertising asset, shown as advertising asset 541.

The system and methods described herein may dynamically determine advertising assets to be integrated within a virtual environment, and may change those determinations with elapsed time or a change in the time of day, a change in user information or status (including the proximity of a user's in-game character to various placeholder(s) in a scene), with game progress and/or results (e.g., changing an advertisement after an item is picked up or discarded, or upon a second interaction or encounter with the virtual environment or a placeholder or advertising asset), or with the number of hits. In some embodiments, multiple advertising campaigns may be supported in the same game (e.g., at different times or through the alternating of advertising assets placed in the virtual environment).

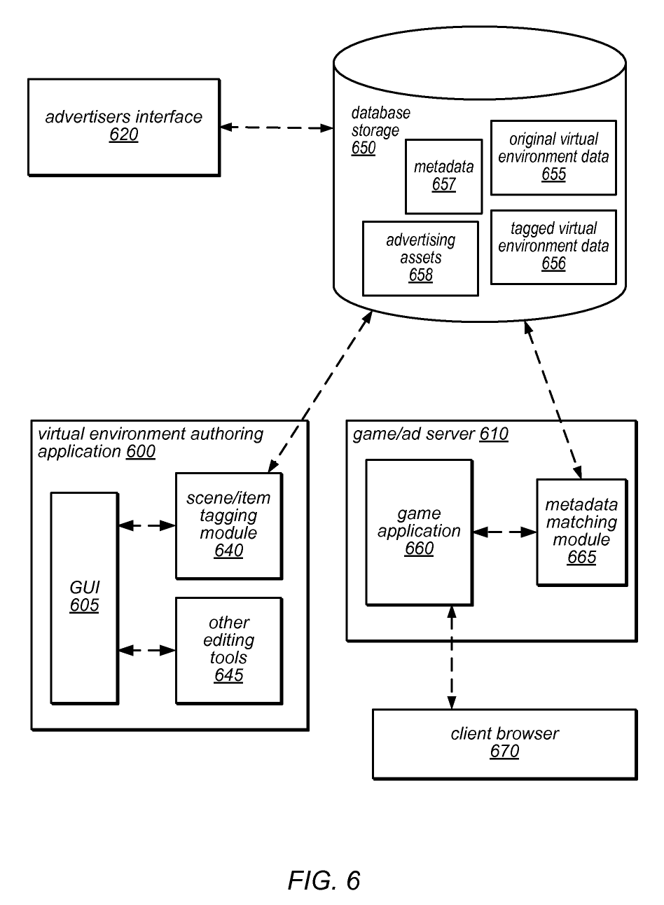

As described herein, a virtual environment authoring application and web server (such as a game server or ad server) may work together to implement dynamic integration of advertisements in virtual environments employed in server-hosted applications (e.g., on-line game applications provided through a client web browser) or client applications (e.g., game applications executing on a client machine that are configured to communicate with a game/ad server at runtime to request and receive context-appropriate advertising assets). FIG. 6 illustrates various components of such a framework, according to one embodiment. In this example, a virtual environment authoring application 600 may include a graphical user interface (GUI) 605, such as the user interface described herein and illustrated in FIGS. 2A and 2B.

Graphical user interface 605 may provide a user (e.g., a graphic designer or application/game designer) with access to various editing tools and input mechanisms to allow the user to tag a virtual environment with placeholders for advertising assets, as described herein. For example, in the embodiment illustrated in FIG. 6, GUI 605 may provide the user access to image/scene tagging module 640, and other virtual environment editing tools 645. These modules and tools may be usable to design or modify a virtual environment, to tag areas and/or items within a virtual environment, and/or to specify and/or modify values of various attributes of tagged areas or items with a virtual environment, as described herein.

In this example, virtual environment authoring application 600 communicates with one or more data storage structures, such as database storage 650, for storing or retrieving data and/or instructions representing original virtual environments (655), tagged virtual environments (656), metadata (657), and/or advertising assets (658). As illustrated in FIG. 6, another interface 620 may be provided to advertisers (or agents thereof) for use in tagging various advertising assets, specifying values of attributes of those assets, and storing those values as metadata 657 associated with those assets 658 in database storage 650.

In the example illustrated in FIG. 6, a game/ad server 610 may include one or more game applications 660, or other applications that employ virtual environments suitable for the application of the methods described herein, and a metadata matching module 665. In other embodiments, a metadata matching module 665 may be provided by game/ad server 610 as a component of a game application 660, rather than as a separate utility. In such embodiments, the metadata matching module 665 may in some embodiments be inserted into the game application 660 by virtual environment authoring application 660 in response to tagging one or more virtual environments of game application 660 with placeholders for advertising assets. In the example illustrated in FIG. 6, metadata matching module 665 may perform a search of database storage 650 for advertising assets having associated attribute values compatible with values of corresponding attribute values associated with placeholders in a virtual environment in response to requests for advertising assets received from game application 660.

As illustrated in FIG. 6, an end user (e.g., a game player or user of another client application employing virtual environments) may communicate with game/ad server 610 to execute a game application 660 through a client browser 670 (e.g., a browser application executing on the user's client computer system). In other embodiments, game application 660 may execute on a user's client computer system, rather than on a game/ad server 610, but may be configured to communicate with game/ad server 610 during runtime to request and receive context-appropriate advertising assets, as described herein.

In various embodiments, once a virtual environment tagging exercise has been completed, or at any intermediate point in the tagging exercise, data representing the tagged virtual environment may be stored in database storage 650. For example, in response to user input, data representing a tagged virtual environment may be exported from virtual environment authoring application 600 for integration with a suitable user application, for publication on a website, for display, or for printing, in addition to, or instead of, being written to a computer readable storage medium, such as a storage medium comprising database storage 650 in FIG. 6, for archival purposes and/or to be accessible to game/ad server 610, game application 660, or another application subsequent to the tagging exercise.

In various embodiments, virtual environment authoring application 600, game/ad server 610, and/or database storage 650 may be implemented on a single computer system, or may be implemented on two or more computer systems, and/or may be partitioned into two or more modules in a manner different from those illustrated in FIG. 6.

While various examples included herein describe the application of the methods to game applications, they may in other embodiments be applied to any application employing virtual environments and for which dynamic, context-sensitive placement of advertising assets or other changeable 3D models is appropriate, e.g., medical imaging application, virtual travel or tour applications, etc.

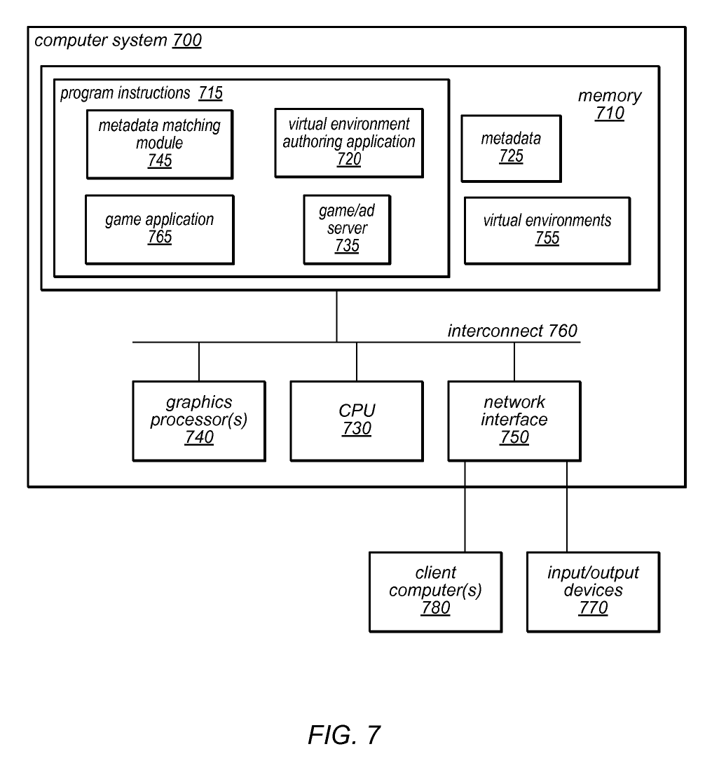

The methods described herein for dynamic integration of advertisements in virtual environments may be implemented by a computer system configured to provide the functionality described. FIG. 7 is a block diagram illustrating one embodiment of a computer system 700 configured to implement such functionality. In various embodiments, computer system 700 may be any of various types of devices, including, but not limited to, a personal computer system, desktop computer, laptop or notebook computer, mainframe computer system, handheld computer, workstation, network computer, a consumer device, video game console, handheld video game device, application server, storage device, a peripheral device such as a switch, modem, router, or in general any type of computing device.

As illustrated in FIG. 7, computer system 700 may include one or more processor units (CPUs) 730. Processors 730 may be implemented using any desired architecture or chip set, such as the SPARC™ architecture, an x86-compatible architecture from Intel Corporation or Advanced Micro Devices, or another architecture or chipset capable of processing data, and may in various embodiments include multiple processors, a single threaded processor, a multi-threaded processor, a multi-core processor, or any other type of general-purpose or special-purpose processor. Any desired operating system(s) may be run on computer system 700, such as various versions of Unix, Linux, Windows™ from Microsoft Corporation, MacOS™ from Apple Corporation, or any other operating system that enables the operation of software on a hardware platform.

The computer system 700 may also include one or more system memories 710 (e.g., one or more of cache, SRAM, DRAM, RDRAM, EDO RAM, DDR RAM, SDRAM, Rambus RAM, EEPROM, or other memory type), or other types of RAM or ROM) coupled to other components of computer system 700 via interconnect 760. Memory 710 may include other types of memory as well, or combinations thereof. One or more of memories 710 may include program instructions 715 executable by one or more of processors 730 to implement aspects of the techniques described herein. Program instructions 715, which may include program instructions configured to implement virtual environment authoring application 720, game/ad server 735, game application 765, and/or metadata module 745, may be partly or fully resident within the memory 710 of computer system 700 at any point in time. Alternatively, program instructions 715 may be provided to graphics processor (GPU) 740 for performing virtual environment tagging operations, metadata matching, or other operations described herein as part of dynamically integrating advertisements in virtual environments on GPU 740 using one or more of the techniques described herein. In some embodiments, the techniques described herein may be implemented by a combination of program instructions 715 executed on one or more processors 730 and one or more GPUs 740, respectively. Program instructions 715 may also be stored on an external storage device (not shown) accessible by the processor(s) 730 and/or GPU 740, in some embodiments. Any of a variety of such storage devices may be used to store the program instructions 715 in different embodiments, including any desired type of persistent and/or volatile storage devices, such as individual disks, disk arrays, optical devices (e.g., CD-ROMs, CD-RW drives, DVD-ROMs, DVD-RW drives), flash memory devices, various types of RAM, holographic storage, etc. The storage devices may be coupled to the processor(s) 730 and/or GPU 740 through one or more storage or I/O interfaces including, but not limited to, interconnect 760 or network interface 750, as described herein. In some embodiments, the program instructions 715 may be provided to the computer system 700 via any suitable computer-readable storage medium including memory 710 and/or external storage devices described above. Memory 710 may also be configured to implement one or more data structures, such as one or more data structures configured to store metadata 725 and/or data and instructions representing tagged or untagged virtual environments 755, as described herein. Metadata 725 and/or virtual environments 755 may be accessible by processor(s) 730 and/or GPU 740 when executing virtual environment authoring application 720, game/ad server 735, metadata matching module 745, game application 765, or other program instructions 715.

Any or all of the functionality described herein may be provided as a computer program product, or software, that may include a computer-readable storage medium having stored thereon instructions, which may be used to program a computer system (or other electronic devices) to implement dynamic integration of advertisements in a virtual environment using the techniques described herein. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; electrical, or other types of medium suitable for storing program instructions. Alternatively, program instructions may be communicated using optical, acoustical or other form of propagated signal (e.g., carrier waves, infrared signals, digital signals, or other types of signals or mediums.).

As shown in FIG. 7, processor(s) 730 may be coupled to one or more of the other illustrated components by at least one communications bus, such as interconnect 760 (e.g., a system bus, LDT, PCI, ISA, or other communication bus type), and a network interface 750 (e.g., an ATM interface, an Ethernet interface, a Frame Relay interface, or other interface). The CPU 730, the GPU 740, the network interface 750, and the memory 710 may be coupled to the interconnect 760. It should also be noted that one or more components of system 700 may be located remotely and accessed via a network.

As noted above, in some embodiments, memory 710 may include program instructions 715, comprising program instructions configured to implement virtual environment authoring application 720, game/ad server 735, game application 765, and/or metadata module 745, as described herein. Program instructions 715 may be implemented in various embodiments using any desired programming language, scripting language, or combination of programming languages and/or scripting languages, e.g., C, C++, C#, Java™, Perl, etc. For example, in one embodiment, virtual environment authoring application 720, game/ad server 735, game application 765, and/or metadata module 745, may be JAVA based, while in another embodiments, any or all of these components may be implemented using the C or C++ programming languages. In other embodiments, virtual environment authoring application 720, game/ad server 735, game application 765, and/or metadata module 745 may be implemented using specific graphic languages specifically for developing programs executed by specialize graphics hardware, such as GPU 740. In addition, virtual environment authoring application 720, game/ad server 735, game application 765, and/or metadata module 745 may be embodied on memory specifically allocated for use by graphics processor(s) 740, such as memory on a graphics board including graphics processor(s) 740. Thus, memory 710 may represent dedicated graphics memory as well as general-purpose system RAM, in various embodiments. Other information not described herein may be included in memory 710 and may be used to implement the methods described herein and/or other functionality of computer system 700. In some embodiments, program instructions 715, or any component thereof, may represent various types of graphics applications, such as painting, publishing, photography, games, animation, and other applications that may include program instructions executable to provide the functionality described herein.

A graphics processing unit or GPU may be considered a dedicated graphics-rendering device for a personal computer, workstation, game console or other computer system. Modern GPUs may be very efficient at manipulating and displaying computer graphics and their highly parallel structure may make them more effective than typical CPUs for a range of complex graphical algorithms. For example, graphics processor 740 may implement a number of graphics primitive operations in a way that makes executing them much faster than drawing directly to the screen with a host central processing unit (CPU), such as CPU 730. In various embodiments, the methods disclosed herein for virtual environment authoring, or for providing game/ad server 735, game application 765, or metadata matching module 745 may be implemented by program instructions configured for parallel execution on two or more such GPUs. The GPU 700 may implement one or more application programmer interfaces (APIs) that permit programmers to invoke the functionality of the GPU. Suitable GPUs may be commercially available from vendors such as NVIDIA Corporation, ATI Technologies, and others.

Network interface 750 may be configured to enable computer system 700 to communicate with other computers, systems or machines, such as across a network. For example, an end user may access virtual environment authoring application 720 or game application 765 via a graphical user interface executing on a client computer 780 configured to communicate with computer system 700 through network interface 750. In another example, a user may communicate with one of more components of program instructions 715 via input/output devices 770 configured to communicate with computer system 700 through network interface 750. Network interface 750 may use standard communications technologies and/or protocols, and may utilize links using technologies such as Ethernet, 702.11, integrated services digital network (ISDN), digital subscriber line (DSL), and asynchronous transfer mode (ATM) as well as other communications technologies. Similarly, the networking protocols used on a network to which computer system 700 is interconnected may include multi-protocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP), among other network protocols. The data exchanged over such a network by network interface 750 may be represented using technologies, languages, and/or formats, such as the hypertext markup language (HTML), the extensible markup language (XML), and the simple object access protocol (SOAP) among other data representation technologies. Additionally, all or some of the links or data may be encrypted using any suitable encryption technologies, such as the secure sockets layer (SSL), Secure HTTP and/or virtual private networks (VPNs), the international data encryption standard (DES or IDEA), triple DES, Blowfish, RC2, RC4, RC5, RC6, as well as other data encryption standards and protocols. In other embodiments, custom and/or dedicated data communications, representation, and encryption technologies and/or protocols may be used instead of, or in addition to, the particular ones described above.

GPUs, such as GPU 740 may be implemented in a number of different physical forms. For example, GPU 740 may take the form of a dedicated graphics card, an integrated graphics solution and/or a hybrid solution. GPU 740 may interface with the motherboard by means of an expansion slot such as PCI Express Graphics or Accelerated Graphics Port (AGP) and thus may be replaced or upgraded with relative ease, assuming the motherboard is capable of supporting the upgrade. However, a dedicated GPU is not necessarily removable, nor does it necessarily interface the motherboard in a standard fashion. The term “dedicated” refers to the fact that hardware graphics solution may have RAM that is dedicated for graphics use, not to whether the graphics solution is removable or replaceable. Dedicated GPUs for portable computers may be interfaced through a non-standard and often proprietary slot due to size and weight constraints. Such ports may still be considered AGP or PCI express, even if they are not physically interchangeable with their counterparts. As illustrated in FIG. 7, memory 710 may represent any of various types and arrangements of memory, including general-purpose system RAM and/or dedication graphics or video memory.

Integrated graphics solutions, or shared graphics solutions are graphics processors that utilize a portion of a computer's system RAM rather than dedicated graphics memory. For instance, modern desktop motherboards normally include an integrated graphics solution and have expansion slots available to add a dedicated graphics card later. As a GPU may be extremely memory intensive, an integrated solution finds itself competing for the already slow system RAM with the CPU, as the integrated solution has no dedicated video memory. For instance, system RAM may experience a bandwidth between 2 GB/s and 8 GB/s, while most dedicated GPUs enjoy from 15 GB/s to 30 GB/s of bandwidth. Hybrid solutions may also share memory with the system memory, but may have a smaller amount of memory on-board than discrete or dedicated graphics cards to make up for the high latency of system RAM. Data communicated between the graphics processing unit 740 and the rest of the computer system 700 may travel through a graphics card slot or other interface, such as interconnect 760 of FIG. 7.

Computer system 700 may also include one or more additional I/O interfaces, such as interfaces for one or more user input devices 770, or such devices may be coupled to computer system 700 via network interface 750. For example, computer system 700 may include interfaces to a keyboard, a mouse or other cursor control device, a joystick, or other user input devices 770, in various embodiments. Additionally, the computer system 700 may include one or more displays (not shown), coupled to processors 730 and/or other components via interconnect 760 or network interface 750. Such input/output devices may be configured to allow a user to interact with virtual environment authoring application 720 and/or game application 765, as described herein. For example, they may be configured to allow a user to specify the location of a placeholder in a virtual environment, to specify values of placeholder or item attributes, or to exercise various user controls of a game application, in different embodiments. It will be apparent to those having ordinary skill in the art that computer system 700 may also include numerous other elements not shown in FIG. 7.

Note that program instructions 715 may be configured to implement a virtual environment authoring application 720 or metadata matching module 745 as a stand-alone application, or as a module of another graphics application or graphics library, in various embodiments. For example, in one embodiment program instructions 715 may be configured to implement graphics applications such as painting, publishing, photography, games, animation, and/or other applications, and may be configured to tag and/or otherwise modify virtual environments, or to access tagged virtual environments as part of one or more of these graphics applications. In another embodiment, program instructions 715 may be configured to implement the techniques described herein in one or more functions called by another graphics application executed on GPU 740 and/or processor(s) 730. Program instructions 715 may also be configured to render images and present them on one or more displays as the output of virtual environment tagging operation and/or to store data for tagged virtual environments in memory 710 and/or an external storage device(s), in various embodiments. For example, a virtual environment authoring application 720 included in program instructions 715 may utilize GPU 740 when tagging, modifying, rendering, or displaying virtual environments in some embodiments.

While various image upsampling techniques have been described herein with reference to various embodiments, it will be understood that these embodiments are illustrative and are not meant to be limiting. Many variations, modifications, additions, and improvements are possible. More generally, various techniques are described in the context of particular embodiments. For example, the blocks and logic units identified in the description are for ease of understanding and are not meant to be limiting to any particular embodiment. Functionality may be separated or combined in blocks differently in various realizations or described with different terminology. In various embodiments, actions or functions described herein may be performed in a different order than illustrated or described. Any of the operations described may be performed programmatically (i.e., by a computer according to a computer program). Any of the operations described may be performed automatically (i.e., without user intervention).

The embodiments described herein are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations described herein may be implemented as a combined structure or component. These and other variations, modifications, additions, and improvements may fall within the scope as defined in the claims that follow.

Although the embodiments above have been described in detail, numerous variations and modifications will become apparent to those skilled in the art once the above disclosure is fully appreciated. It is intended that the following claims be interpreted to embrace all such variations and modifications.

1. A method, comprising:
performing, by a computer:
executing a virtual environment authoring application, wherein said executing comprises:
accessing data representing a virtual environment;
receiving input designating a region of the virtual environment or an object in the virtual environment as a placeholder in the virtual environment, wherein a placeholder represents a location within the virtual environment at which an advertising asset can be subsequently placed;
receiving input specifying a value of a classification attribute of the placeholder;
receiving input specifying a value of another attribute of the placeholder, wherein the other attribute comprises a physics attribute wherein the physics attribute is an attribute that defines a physics property to which an advertising asset that is placed at the location within the virtual environment represented by a placeholder is subjected in response to a specified interaction with the advertising asset, wherein the physics property comprises at least one of gravity, vapor pressure, mass, volume, material composition and/or rigid body collision;
storing the value of the classification attribute and the value of the other attribute of the placeholder as metadata of the placeholder, wherein said storing comprises storing the metadata in association with an identifier of the placeholder;
inserting data representing instructions into the data representing the virtual environment to produce data representing a tagged virtual environment, wherein the inserted instructions are executable to:
request an advertising asset that is compatible with the stored value of the classification attribute of the placeholder and the stored value of the other attribute of the placeholder;
receive data representing an advertising asset that is compatible with the stored value of the classification attribute of the placeholder and the stored value of the other attribute of the placeholder, and
integrate the received advertising asset into the tagged virtual environment in place of the placeholder; and
storing the data representing the tagged virtual environment for subsequent use in an application comprising one or more virtual environment representations.

2. The method of claim 1, further comprising:
receiving input specifying a respective value of each of one or more additional attributes of the placeholder; and
storing the respective value for each of the additional attributes of the placeholder as additional metadata of the placeholder, wherein staring the respective value for each of the additional attributes comprises storing, the additional metadata in association with the identifier of the placeholder.

3. The method of claim 2, wherein the one or more additional attributes comprise a visual attribute, a physical attribute, a behavioral attribute, or an interactivity attribute, wherein a behavioral attribute is an attribute that defines a behavior that can be exhibited by an advertising asset that is placed at the location within the virtual environment represented by a placeholder, and wherein an interactivity attribute is an attribute that defines an action to be taken in response to a specified interaction with an advertising asset that is placed at the location within the virtual environment represented by a placeholder.

4. The method of claim 1, wherein the input designating a region of the virtual environment or an object in the virtual environment as the placeholder designates an image or frame of the virtual environment as the placeholder.

5. The method of claim 1, wherein the input designating a region of the virtual environment or an object in the virtual environment as the placeholder designates a region of an image or frame of the virtual environment that is less than the entire image or frame as the placeholder.

6. The method of claim 1, wherein the input designating a region of the virtual environment or an object in the virtual environment as the placeholder designates an object in an image or frame of the virtual environment as the placeholder

7. The method of claim 1, further comprising:
inserting data representing instructions configured to capture user or session information during execution of the application into the data representing the tagged virtual environment.

8. The method of claim 1, wherein the application is an on-line game application.

9. The method of claim 1, wherein the data representing the virtual environment comprises data representing a three-dimensional virtual environment.

10. A method, comprising:
performing, by a computer:
receiving a request from an executing application for an advertising asset that is compatible with a placeholder to be integrated into a virtual environment displayed by the application, wherein the request comprises an indicator of the placeholder, and wherein the placeholder represents a location within the virtual environment at which the advertising asset is to be integrated;
dynamically determining a given advertising asset that is compatible with the placeholder dependent on metadata that is stored in association with an identifier of the placeholder, wherein the metadata that is stored in association with an identifier of the placeholder comprises a value of a classification attribute of the placeholder and a value of another attribute of the placeholder, wherein the other attribute comprises a physics attribute for the placeholder, wherein the physics attribute is an attribute that defines a physics property to which an advertising asset that is placed at the location within the virtual environment represented by a placeholder is subjected in response to a specified interaction with the advertising asset, wherein the physics property comprises at least one of gravity, vapor pressure, mass, volume material composition and/or rigid body collision, and
providing data representing the given advertising asset to the application for integration into the virtual environment in place of the placeholder.

11. The method of claim 10, wherein the data representing the given advertising asset comprises a three-dimensional model of a product or of an advertisement of a product

12. The method of claim 10, wherein said dynamically determining comprises selecting an advertising asset for which metadata associated with the advertising asset is compatible with the metadata that is stored in association with an identifier of the placeholder.

13. The method of claim 12, wherein the metadata associated with the given advertising asset comprises a value of a classification attribute, a visual attribute, a physical attribute, a physics attribute, a behavioral attribute, or an interactivity attribute.

14. The method of claim 10, wherein the metadata that is stored in association with an identifier of the placeholder further comprises a value of a visual attribute, or a physical attribute, a behavioral attribute, or an interactivity attribute, wherein a behavioral attribute is an attribute that defines a behavior that can be exhibited by an advertising asset that is placed at the location within the virtual environment represented by a placeholder, and wherein an interactivity attribute is an attribute that defines an action to be taken in response to a specified interaction with an advertising asset that is placed at the location within the virtual environment represented by a placeholder.

15. The method of claim 10, further comprising:
receiving data specific to a current user of the executing application or a current session of the executing application;
wherein said dynamically determining is further dependent on the received user-specific or session-specific data.

16. The method of claim 10, further comprising:
receiving an indication of an interaction with the given advertising asset in the virtual environment; and
in response to receiving the indication:
dynamically determining a second advertising asset to be integrated into the virtual environment dependent on the value of an interactivity attribute of the given advertising asset or the value of an interactivity attribute of the placeholder; and
providing data representing the second advertising asset to the application for integration into the virtual environment,

17. A method, comprising:
performing, by a computer:
accessing data representing a virtual environment during execution of an application, wherein the data representing the virtual environment comprises data designating a region of the virtual environment or an object in the virtual environment as a placeholder in the virtual environment, wherein the placeholder represents a location within the virtual environment at which an advertising asset can be subsequently integrated;
requesting an advertising asset that is compatible with metadata that is stored in association with an identifier of the placeholder, wherein the request comprises an indication of the placeholder, wherein the metadata that is stored in association with an identifier of the placeholder specifies a value of a classification attribute of the placeholder and a value of another attribute of the placeholder, wherein the other attribute comprises a physics attribute for the placeholder, wherein the physics attribute is an attribute that defines a physics property to which an advertising asset that is placed at the location within the virtual environment represented by a placeholder is subjected in response to a specified interaction with the advertising asset, wherein the physics property comprises at least one of gravity, vapor pressure, mass volume material. composition and/or rigid body collision;
receiving data representing a given advertising asset, wherein metadata associated with the given advertising asset is compatible with the metadata that is stored in association with an identifier of the placeholder
integrating the received data into the data representing the virtual environment in place of the placeholder; and
presenting the data representing the virtual environment and the given advertising asset.

18. The method of claim 17, wherein the data representing the given advertising asset comprises a three-dimensional model of a product or of an advertisement of a product.

19. The method of claim 17, wherein the metadata associated with the given advertising asset comprises a value of a classification attribute, a visual attribute, a physical attribute, a physics attribute, a behavioral attribute, or an. interactivity attribute.

20. The method of claim 17, wherein the metadata that is stored in association with an identifier of the placeholder further comprises a value of a visual attribute, a physical attribute, a behavioral attribute, or an interactivity attribute, wherein a behavioral attribute is an attribute that defines a behavior that can be exhibited by an advertising asset that is placed at the location within the virtual environment represented by a placeholder, and wherein an interactivity attribute is an attribute that defines an action to be taken in response to a specified interaction with an advertising asset that is placed at the location within the virtual. environment represented by a placeholder.

21. The method of claim 17, wherein the request further comprises data specific to a current user of the application or a current session of the application, and wherein the metadata associated with the given advertising asset is further compatible with the user-specific or session-specific data.

22. The method of claim 17, further comprising:
requesting a second advertising asset that is compatible with the metadata that is stored in association with the identifier of the placeholder, wherein the request comprises the indication of the placeholder and an indication of an interaction with the given advertising asset in the virtual environment;
receiving a second advertising asset to be integrated into the virtual environment, wherein the second advertising asset is compatible with the indication of the interaction and is compatible with the value of an interactivity attribute of the given advertising asset or the value of an interactivity attribute of the placeholder; and
providing data representing the second advertising asset to the application for integration into the virtual environment

23. A system, comprising:
one or more processors; and
a memory coupled to the one or more processors and storing program instructions executable by the one or more processors to perform:
accessing data representing a virtual environment;
receiving input designating a region of the virtual environment or an object in the virtual environment as a placeholder in the virtual environment, wherein a placeholder represents a location within the virtual environment at which an advertising asset can be subsequently placed;
receiving input specifying a value of a classification attribute of the placeholder;
receiving input specifying a value of another attribute of the placeholder, wherein the other attribute comprises a physics attribute, wherein a physics attribute is an attribute that defines an action a physics property to which an advertising asset that is placed at the location within the virtual environment represented by a placeholder is subjected in response to a specified interaction with the advertising asset, wherein the physics property comprises at least one of gravity, vapor pressure, mass volume, material composition and/or rigid body collision;
storing the value of the classification attribute and the value of the other attribute of the placeholder as metadata of the placeholder, wherein said storing comprises storing the metadata in association with an identifier of the placeholder;
inserting data representing instructions into the data representing the virtual environment to produce data representing a tagged virtual environment, wherein the inserted instructions are executable to:
request an advertising asset that is compatible with the stored value of the classification attribute of the placeholder and the stored value of the other attribute of the placeholder;
receive data representing an advertising asset that is compatible with the stored value of the classification attribute of the placeholder and the stored value of the other attribute of the placeholder; and
integrate the received advertising asset into the tagged virtual environment in place of the placeholder; and
storing the data representing the tagged virtual environment for subsequent use in an application comprising one or more virtual environment representations.

24. The system of claim 23, wherein the program instructions are further executable by the one or more processors to perform:
receiving input specifying a respective value of each of one or more additional attributes of the placeholder and
storing the respective value for each of the additional attributes of the placeholder as additional metadata of the placeholder, wherein storing the respective value for each of the additional attributes comprises storing the additional metadata in association with the identifier of the placeholder.

25. The system of claim 24, wherein the one or more additional attributes comprise a visual attribute, a physical attribute, a behavioral attribute, or an interactivity attribute, wherein a behavioral attribute is an attribute that defines a behavior that can be exhibited by an advertising asset that is placed at the location within the virtual environment represented by a placeholder, and wherein an interactivity attribute is an attribute that defines an action to be taken in response to a specified interaction with an advertising asset that is placed at the location within the virtual environment represented by a placeholder.

26. The system of claim 23, wherein the input designating a region of the virtual environment or an object in the virtual environment as the placeholder designates an image or frame of the virtual environment as the placeholder.

27. The system of claim 23, wherein the input designating a region of the virtual environment or an object in the virtual environment as the placeholder designates a region of an image or frame of the virtual environment that is less than the entire image or frame as the placeholder.

28. The system of claim 23, wherein the input designating a region of the virtual environment or an object in the virtual environment as the placeholder designates an object in an image or frame of the virtual environment as the placeholder.

29. The system of claim 23, wherein the program instructions are further executable by the one or more processors to perform:
inserting data representing instructions configured to capture user or session information during execution of the application into the data representing the tagged virtual environment.

30. The system of claim 23, wherein the data representing the virtual environment comprises data representing a three-dimensional virtual environment.

31. The system of claim 23, wherein the one or more processors comprise at least one of a general-purpose central processing unit (CPU) or a graphics processing unit (GPU)

32. A non-transitory, computer-readable storage medium, storing program instructions that when executed on one or more computers cause the one or more computers to perform:
accessing data representing a virtual environment;
receiving input designating a region of the virtual environment or an object in the virtual environment as a placeholder in the virtual environment, wherein a placeholder represents a location within the virtual environment at which an advertising asset can be subsequently placed;
receiving input specifying a value of a classification attribute of the placeholder;
receiving input specifying a value of another attribute of the placeholder, wherein the other attribute comprises a physics attribute, the physics attribute is an a physics property to which an advertising asset that is placed at the location within the virtual environment represented by a placeholder is subjected in response to a specified interaction with the advertising asset, wherein the physics property comprises at least one of gravity, vapor pressure, mass, volume, material composition and/or rigid body collision;
storing the value of the classification attribute and the value of the other attribute of the placeholder as metadata of the placeholder, wherein said storing comprises storing the metadata in association with an identifier of the placeholder;
inserting data representing instructions into the data representing the virtual environment to produce data representing a tagged virtual environment, wherein the inserted instructions are executable to:
request an advertising asset that is compatible with the stored value of the classification attribute of the placeholder and the stored value of the other attribute of the placeholder,
receive data representing an advertising asset that is compatible with the stored value of the classification attribute of the placeholder and the stored value of the other attribute of the placeholder, and
integrate the received advertising asset into the tagged virtual environment in place of the placeholder, and
storing the data representing the tagged virtual environment for subsequent use in an application comprising one or more virtual environment representations.

33. The storage medium of claim 32, wherein when executed on the one or more computers the program instructions further cause the one or more computers to perform:
receiving input specifying a respective value of each of one or more additional attributes of the placeholder; and
storing the respective value for each of the additional attributes of the placeholder as additional metadata of the placeholder, wherein storing the respective value for each of the additional attributes comprises storing the additional metadata in association with the identifier of the placeholder.

34. The storage medium of claim 33, wherein the one or more additional attributes comprise a visual attribute, a physical attribute, a behavioral attribute, or an interactivity attribute, wherein a behavioral attribute is an attribute that defines a behavior that can be exhibited by an advertising asset that is placed at the location within the virtual. environment represented by a placeholder, and wherein an interactivity attribute is an attribute that defines an action to be taken in response to a specified interaction with an advertising asset that is placed at the location within the virtual environment represented by a placeholder.

35. The storage medium of claim 32, wherein the input designating a region of the virtual environment or an object in the virtual environment as the placeholder designates an image or frame of the virtual environment as the placeholder.

36. The storage medium of claim 32, wherein the input designating a region of the virtual environment or an object in the virtual environment as the placeholder designates a region of an image or frame of the virtual environment that is less than the entire image or frame as the placeholder.

37. The storage medium of claim 32, wherein the input designating a region of the virtual environment or an object in the virtual environment as the placeholder designates an object in an image or frame of the virtual environment as the placeholder.

38. The storage medium of claim 32, wherein the program instructions are further computer-executable to implement:
inserting data representing instructions configured to capture user or session information during execution of the application into the data representing the tagged virtual environment.

39. The storage medium of claim 32, wherein the data representing the virtual environment comprises data representing a three-dimensional virtual environment.

40. A computer-implemented method, comprising:
executing instructions on a specific apparatus so that binary digital electronic signals representing a virtual environment are accessed in memory;
executing instructions on said specific apparatus to receive binary digital electronic signals representing input designating a region of the virtual environment or an object in the virtual environment as a placeholder in the virtual environment, wherein a placeholder represents a location within the virtual environment at which an advertising asset can be subsequently placed;
executing instructions on said specific apparatus to receive binary digital electronic signals representing a value of a classification attribute of the placeholder;
executing instructions on said specific apparatus to receive binary digital electronic signals representing a value of another attribute of the placeholder, wherein the other attribute comprises a physics attribute, wherein the physics attribute is an attribute that defines a physics property to which an advertising asset that is placed at the location within the virtual environment represented by a placeholder is subjected in response to a specified interaction with the advertising asset, wherein the physics property comprises at least one of gravity, vapor pressure, mass, volume, material composition and/or rigid body collision;
storing the binary digital electronic signals representing the value of the classification attribute and the value of the other attribute of the placeholder in a memory location of said specific apparatus as metadata of the placeholder, wherein said storing comprises storing the metadata in association with an identifier of the placeholder;
executing instructions on said specific apparatus so that binary digital electronic signals representing instructions are inserted into the binary digital electronic signals representing the virtual environment to produce binary digital electronic signals representing a tagged virtual environment, wherein the inserted instructions are executable to:
request an advertising asset that is compatible with the stored value of the classification attribute of the placeholder and the stored value of the other attribute of the placeholder;
receive binary digital electronic signals representing an advertising asset that is compatible with the stored value of the classification, attribute of the placeholder and the stored value of the other attribute of the placeholder; and
integrate the received advertising asset into the tagged virtual environment in place of the placeholder; and
storing the binary digital electronic signals representing the tagged virtual environment in a memory location of said specific apparatus for subsequent use in an application comprising one or more virtual environment representations.

41. The method of claim 1, wherein the physics property is gravity.

42. The method of claim 1, wherein the physics property is a rigid body collision
